(19) United States
(12) Patent Application Publication
(10) Pub. No.: US 2015/0234985 A1
(43) Pub. Date: Aug. 20, 2015

(54) RF TRANSACTION SYSTEM AND METHOD FOR STORING USER PERSONAL DATA

(71) Applicant: XATRA FUND MX, LLC, Wilmington, DE (US)

(72) Inventor: Peter D. Saunders, Salt Lake City, UT (US)

(21) Appl. No.: 14/703,443

(22) Filed: May 4, 2015

Related U.S. Application Data
(63) Continuation of application No. 10/711,964, filed on Oct. 15, 2004, now Pat. No. 9,024,719.
Application No. 10/711,964 is a continuation-in-part of application No. 10/340,352, filed on Jan. 10, 2003, now Pat. No. 7,889,052.
Application No. 10/340,352 is a continuation-in-part of application No. 10/192,488, filed on Jul. 9, 2002, now Pat. No. 7,239,226.
Application No. 10/340,352 is a continuation-in-part of application No. 10/318,432, filed on Dec. 13, 2002.
Application No. 10/340,352 is a continuation-in-part of application No. 10/318,480, filed on Dec. 13, 2002, now Pat. No. 7,249,112.
(60) Provisional application No. 60/512,297, filed on Oct. 17, 2003.
(60) Provisional application No. 60/396,577, filed on Jul. 16, 2002.
(60) Provisional application No. 60/304,216, filed on Jul. 10, 2001.
(60) Provisional application No. 60/396,577, filed on Jul. 16, 2002.
(60) Provisional application No. 60/396,577, filed on Jul. 16, 2002.

(51) Int. Cl. G06F 19/00; G06K 7/10

(52) U.S. Cl. CPC G06F 19/323; G06K 7/10366

(57) ABSTRACT

A system and method for a RF transaction device for storing user personal data is disclosed. The invention includes a system and method for facilitating a healthcare transaction using a transponder system configured to store different healthcare information in different storage areas on a database. The invention includes providing account information in ISO/IEC 7816 magnetic stripe Track 1/Track 2 format. The invention also includes an RFID reader for transmitting account and database information. In one embodiment the invention provides an RFID reader as a free standing or a computer implemented device. In another embodiment, biometric security measures are used in conjunction with the transponder system. In another embodiment, the transponder system communicates with one or more third-party healthcare providers to facilitate the transfer of healthcare and personal information.

This application is a Continuation of U.S. Ser. No. 10/711,964, filed Oct. 15, 2004; which is a Non-Provisional of U.S. Provisional Application No. 60/512,297, filed Oct. 17, 2003. U.S. application Ser. No. 10/711,964 is also a Continuation-In-Part of U.S. Ser. No. 10/340,352, filed Jan. 10, 2003, now U.S. Pat. No. 7,889,052, issued Feb. 15, 2011; which is a Non-Provisional of U.S. Provisional Application No. 60/396,577, filed Jul. 16, 2002 and Continuation-In-Part of U.S. application Ser. No. 10/192,488, filed Jul. 9, 2002, now U.S. Pat. No. 7,239,226, issued Jul. 3, 2007; which is a Non-Provisional of U.S. Provisional Application No. 60/304,216, filed Jul. 10, 2001. U.S. application Ser. No. 10/340,352 is also a Continuation-In-Part of U.S. application Ser. No. 10/318,432, filed Dec. 13, 2002; which is a Non-Provisional of U.S. Provisional Application No. 60/396,577, filed Jul. 16, 2002. U.S. application Ser. No. 10/340,352 is also a Continuation-In-Part of U.S. application Ser. No. 10/318,480, filed Dec. 13, 2002, now U.S. Pat. No. 7,249,112, issued Jul. 24, 2007. U.S. application Ser. No. 10/318,480 is also a Non-Provisional of U.S. Provisional Application No. 60/396,577, filed Jul. 16, 2002. All of the foregoing applications as incorporated herein by reference.

### FIELD OF INVENTION

This invention generally relates to systems and methods for storing and accessing personal information on a Radio Frequency (RF) transponder, more specifically, to storing and accessing healthcare information.

### BACKGROUND OF INVENTION

The U.S. Department of Health and Human Services has recently launched a new plan to convert the present healthcare information infrastructure to a nationwide, electronic network for healthcare information. Currently, only thirteen percent of hospitals nationwide have electronic systems, and only 14 to 28 percent of other physicians maintain electronic systems.

Electronic healthcare systems provide many challenges. For example, oftentimes, physicians and hospitals use computer systems for billing, while they use manual filing systems for tracking medical records. Therefore, information can be lost, mislaid, or inputted incorrectly for billing purposes. Recently, different software systems, such as CareRevolution by Electronic Healthcare Systems, have provided single point-of-care products that provide one database for both billing and medical information.

Nevertheless, medical and billing information must still be transferred from the patients to the physicians manually. Further, with patients moving and increased traveling, often the patient may not have all his medical information in one place and/or on hand when he needs medical attention. While current healthcare systems allow information to be maintained and held by the healthcare provider, it is desirable for such information to be portable and held with the patent instead.

Having the proper patient medical history has been shown to improve medical care and reduce medical errors. Further, improvements in health information technology have been estimated to produce savings of up to ten percent. Therefore, there is a need for a portable device for healthcare information.

### SUMMARY OF INVENTION

A system and method for a RF transaction device for storing user personal data is disclosed. The invention includes a system and method for facilitating a healthcare transaction comprising an RF transponder system configured to store different healthcare information in different storage areas on a database. For example, medical insurance information may be stored in one type of format, while dental insurance information may be stored in a different format. The system and method for facilitating a healthcare transaction provides account information in ISO/IEC 7816 magnetic stripe Track 1/Track 2 format. The invention includes an RFID reader for transmitting account and database information.

In one exemplary embodiment the invention provides an RFID reader as a free standing or a computer implemented device. In another embodiment, biometric security measures are used in conjunction with the transponder system. The biometric security measures include pre-registration of biometric information and proffering biometric samples at biometric sensors configured with the transponder system.

In another exemplary embodiment, the transponder system communicates with one or more third-party healthcare providers to facilitate the transfer of healthcare and personal information. In another embodiment, the transponder system is configured with a GPS device to monitor and track locational information to provide local healthcare information and services.

These features and other advantages of the system and method, as well as the structure and operation of various exemplary embodiments of the system and method, are described below.

### BRIEF DESCRIPTION OF THE DRAWINGS

The accompanying drawings, wherein like numerals depict like elements, illustrate exemplary embodiments of the present invention, and together with the description, serve to explain the principles of the invention. In the drawings:

FIG. 1A illustrates an exemplary RFID-based system in accordance with the present invention, wherein exemplary components used for fob healthcare information are depicted;

FIG. 1B illustrates an exemplary personalization system in accordance with the present invention;

FIG. 2 is a schematic illustration of an exemplary fob in accordance with the present invention;

FIG. 3 is a schematic illustration of an exemplary RFID reader in accordance with the present invention;

FIG. 4 is an exemplary flow diagram of an exemplary authentication process in accordance with the present invention;

FIG. 5 is an exemplary flow diagram of an exemplary decision process for a protocol/sequence controller in accordance with the present invention;

FIGS. 6A-B are an exemplary flow diagram of a fob personalization process in accordance with the present invention;

FIGS. 7A-B are an exemplary flow diagram of a RFID reader personalization process in accordance with the present invention;

FIG. 8 is a flow diagram of an exemplary healthcare information process in accordance with the present invention;

FIG. 9 includes a flowchart illustrating an exemplary healthcare engine system configured to facilitate storing, accessing and transmitting user information;

FIG. 10 includes a flowchart illustrating an exemplary method for enrolling and managing multiple data set owners in accordance with the present invention;

FIG. 11 includes a depiction of an exemplary data set management system in accordance with the present invention;

FIG. 12 illustrates a general overview of an exemplary data set management method in accordance with the present invention;

FIG. 13 illustrates an exemplary method of adding a data set to a fob in accordance with the present invention;

FIG. 14 is a depiction of an exemplary biometrics process in accordance with the present invention;

FIG. 15 is another schematic illustration of an exemplary fob in accordance with the present invention;

FIG. 16 another schematic illustration of an exemplary fob in accordance with the present invention;

FIG. 17 is an exemplary layout of the data stored in track 2 format; and

FIG. 18 is an example of a conventional magnetic stripe track 2 layout for MasterCard;

FIG. 19 illustrates an exemplary data set management method for deleting data sets in accordance with an exemplary embodiment of the present invention;

FIG. 20 illustrates an exemplary method for user self-management of data sets in accordance with an exemplary embodiment of the present invention;

FIG. 21 illustrates an exemplary method for issuer management of data sets in accordance with the present invention; and

FIG. 22 illustrates an exemplary data set selection method for use in completing a transaction.

### DETAILED DESCRIPTION

The detailed description of exemplary embodiments of the invention herein makes reference to the accompanying block diagrams and flowcharts, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Moreover, it should be appreciated that the particular implementations shown and described herein are illustrative of the invention and its best mode and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present invention may be described herein in terms of block diagrams, screen shots and flowcharts, optional selections and various processing steps. Such functional blocks may be realized by any number of hardware and/or software components configured to perform to specified functions. For example, the present invention may employ various integrated circuit components (e.g., memory elements, processing elements, logic elements, look-up tables, and the like), which may carry out a variety of functions under the control of one or more microprocessors or other control devices. Similarly, the software elements of the present invention may be implemented with any programming or scripting language such as C, C++, Java, COBOL, assembler, PERL, extensible markup language (XML), smart card technologies with the various algorithms being implemented with any combination of data structures, objects, processes, routines or other programming elements. Further, it should be noted that the present invention may employ any number of conventional techniques for data transmission, signaling, data processing, network control, and the like.

In addition, many applications of the present invention could be formulated. The exemplary network disclosed herein may include any system for accessing, storing, exchanging and/or otherwise manipulating user information, such as a distributed system, a thin cable network, an Ethernet, a token ring network, the Internet, an intranet, an extranet, wide area network (WAN), local area network (LAN), satellite communications, and/or the like. It is noted that the network may be implemented as other types of networks, such as an interactive television network (ITN).

The system user may interact with the system via any input device such as, a keypad, keyboard, mouse, kiosk, personal digital assistant, handheld computer (e.g., Palm Pilot®, Blueberry®), cellular phone and/or the like). For example, any input device may also be a “pervasive computing device,” such as a traditionally non-computerized device that is embedded with a computing unit, such as, for example, watches, Internet-enabled kitchen appliances, restaurant tables embedded with RF readers, wallets or purses with imbedded transponders, etc. Similarly, the invention could be used in conjunction with any type of personal computer, network computer, work station, minicomputer, mainframe, or the like running any operating system such as any version of Windows, Windows NT, Windows 2000, Windows 98, Windows 95, MacOS, OS/2, BeOS, Linux, UNIX, Solaris, MVS or the like. Moreover, although the invention may frequently be described as being implemented with TCP/IP communications protocol, it should be understood that the invention could also be implemented using SNA, IPX, Appletalk, IPte, NetBIOS, OSI or any number of communications protocols. Moreover, the system contemplates, the use, sale, or distribution of any goods, services or information over any network having a similar functionality described herein.

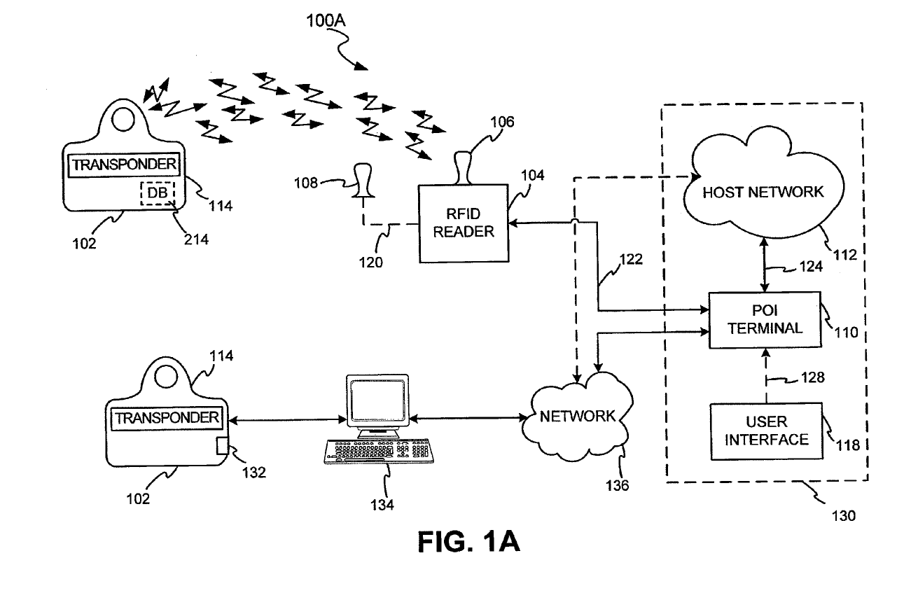

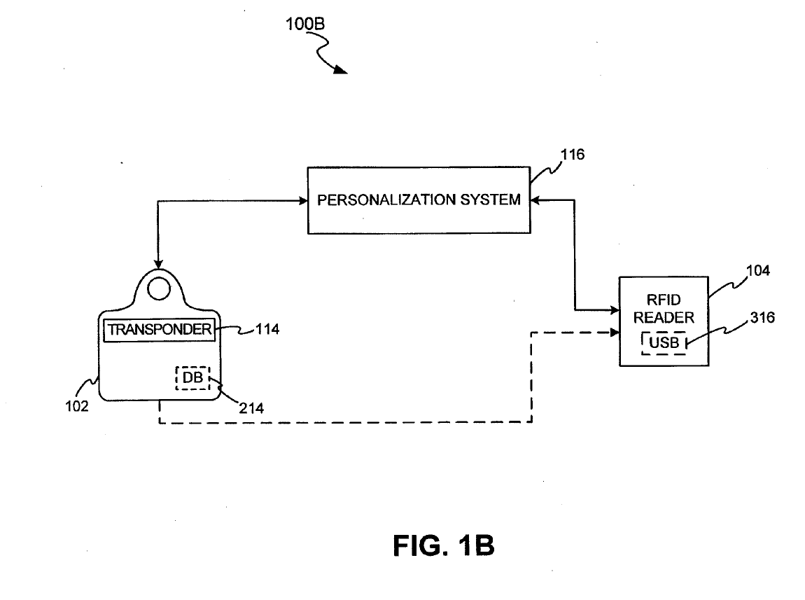

FIG. 1A illustrates an exemplary RFID personal data system 100A that may include fob 102 having a transponder 114 and a RFID reader 104 in radio frequency (RF) communication with fob 102. In general, fob 102 may comprise one or more user databases 214 configured to store user information. These user databases 214 will be described in greater detail herein.

System 100A may be configured to provide access and/or to store user information in databases 214 in order to facilitate healthcare transactions, financial transactions, and/or any other type of transaction.

Fob 102 in accordance with this invention may be used to provide healthcare information, provide user information, pay for medical care, obtain healthcare access, provide identification, pay an amount, receive a payment, redeem reward points and/or the like. In the radio frequency (“RF”) embodiments of fob 102, instrument to instrument transactions may also be performed. See, for example, Sony's “Near Field Communication” (“NFC”) emerging standard which is touted as operating on 13.56 MHz and allowing the transfer of any kind of data between NFC enabled devices across a distance of up to twenty centimeters. See also, Bluetooth chaotic network configurations; described in more detail at http://www.palowireless.com/infotooth/whatis.asp, which is incorporated herein by reference. Furthermore, data on a first RF device may be transmitted directly or indirectly to another RF device to create a copy of all or part of the original device.

Although the present invention is described with respect to fob 102, the invention is not to be so limited. Indeed, system 100A may include any device having a transponder which is configured to communicate with a RFID reader 104 via RF communication. Typical devices may include, for example, a key ring, tag, card, cell phone, wristwatch, clothing or any such form capable of being presented for interrogation. System 100A may also include any non-transponder device configured to facilitate information transactions, such as, for example, credit cards, debit cards, loyalty cards, and the like.

RFID reader 104 may be configured to communicate using a RFID internal antenna 106. Alternatively, RFID reader 104 may include an external antenna 108 for communications with fob 102, where the external antenna may be made remote to RFID reader 104 using a suitable cable and/or data link 120. RFID reader 104 may be further in communication with a healthcare system 130 via a data link 122. System 100A may include a point-of-interaction device such as, for example, a healthcare point-of-interaction (POI) device 110 or a computer interface (e.g., user interface) 134. In one exemplary embodiment system 100A may include healthcare system 130 including POI device 110 in communication with RFID reader 104 (via data link 122). As described more fully below, system 100A may include the user interface 134 connected to a network 136 and to the transponder via a USB connector 132.

As used herein, a user may include any person, resource, product, employee, employer officer, nurse, doctor, health practitioner, hospital administrator, dentist, chiropractor, entity, manager, business, client, corporation, customer, contractor, administrator, operator, pet, equipment, supply, package, hardware and/or software.

The phrase “user information” as used herein, may include any user information such as transaction account information; personal information such as names, addresses, dates of birth, social security numbers, passport numbers, and employment information; healthcare information such as medical history, allergies, medical insurance information, dental insurance information; mortgage information; loyalty point information; membership information and/or any other type of information corresponding to a user. While the invention contemplates the communication, transfer, access and/or storage of any type of user information, the communication, transfer, access and/or storage of healthcare information may be used throughout for exemplary purposes.

Although the point-of-interaction device is described herein with respect to a healthcare point-of-interaction (POI) device, the invention is not to be so limited. Indeed, a healthcare POI device is used herein by way of example, and the point-of-interaction device may be any device capable of receiving fob account data. In this regard, the POI may be any point-of-interaction device enabling the user to complete a transaction and/or transfer information using fob 102. POI device 110 may be in further communication with a user interface 118 (via data link 128) for entering at least a customer's identity verification information. In addition, POI device 110 may be in communication with a healthcare host network 112 (via data link 124) for processing any transaction and/or user information request. In this arrangement, information provided by RFID reader 104 is provided to the POI device 110 of healthcare system 130 via data link 122. POI device 110 may receive the information (and alternatively may receive any identity verifying information from user interface 118 via data link 128) and provide the information to host system 112 for processing.

A variety of conventional communications media and protocols may be used for data links 120, 122, 124, and 128. For example, data links 120, 122, 124, and 128 may be an Internet Service Provider (ISP) configured to facilitate communications over a local loop as is typically used in connection with standard modem communications, cable modems, dish networks, ISDN, Digital Subscriber Lines (DSL), or any wireless communication media. In addition, healthcare system 130, including POI device 110 and host network 112, may reside on a local area network which interfaces to a remote network (not shown) for remote authorization of an intended transaction. Healthcare system 130 may communicate with the remote network via a leased line, such as a T1, D3 line, or the like. Such communications lines are described in a variety of texts, such as, “Understanding Data Communications,” by Gilbert Held, which is incorporated herein by reference.

An account number, as used herein, may include any identifier for an account (e.g., insurance, credit, charge debit, checking, savings, reward, loyalty, or the like) which may be maintained by a healthcare and/or transaction account provider (e.g., payment authorization center) and/or which may be used to complete a transaction. A typical account number (e.g., account data) may be correlated to an insurance account, a credit or debit account, loyalty account, or rewards account maintained and serviced by such entities as American Express®, Visa® and/or MasterCard® or the like. For ease in understanding, the present invention may be described with respect to a medical insurance account.

In addition, the account number (e.g., account data) may be associated with any device, code, or other identifier/indicia suitably configured to allow the user to interact or communicate with the system, such as, for example, authorization/access code, personal identification number (PIN), Internet code, digital certificate, biometric data, and/or other identification indicia. The account number may be optionally located on a medical insurance card, rewards card, charge card, credit card, debit card, prepaid card, telephone card, smart card, magnetic stripe card, bar code card, loyalty card and/or the like. The account number may be distributed and stored in any form of plastic, electronic, magnetic, audio device and/or optical device capable of transmitting or downloading data to a second device. A user account number may be, for example, a sixteen-digit credit card number, although each credit provider has its own numbering system, such as the fifteen-digit numbering system used by American Express®. Each company's credit card numbers comply with that company's standardized format such that the company using a sixteen-digit format will generally use four spaced sets of numbers, as represented by the number “0000 0000 0000 0000”. In a typical example, the first five to seven digits are reserved for processing purposes and identify the issuing bank, card type and, etc. In this example, the last sixteenth digit is used as a sum check for the sixteen-digit number. The intermediary eight-to-ten digits are used to uniquely identify the customer.

In various exemplary embodiments of the present invention, one or more transaction accounts may be used to satisfy or complete a transaction. For example, the transaction may be only partially completed using the transaction account(s) correlating to the application tenant information stored on fob 102 with the balance of the transaction being completed using other sources. Cash may be used to complete part of a transaction and the transaction account associated with a user and fob 102, may be used to satisfy the balance of the transaction. Alternatively, the user may identify which transaction account, or combination of transaction accounts, stored on fob 102 the user desires to complete the transaction. Any known or new methods and/or systems configured to manipulate the transaction account in accordance with the invention may be used.

The account number may be stored as Track 1 and Track 2 data as defined in ISO/IEC 7813, and further may be made unique to fob 102. In one exemplary embodiment, the account number may include a unique fob serial number and user identification number, as well as specific application applets. The account number may be stored in fob 102 inside a database 214, as described more fully below. Database 214 may be configured to store multiple account numbers issued to fob 102 user by the same or different account providing institutions. Where the account data corresponds to a loyalty or rewards account, the database 214 may be configured to store the attendant loyalty or rewards points data.

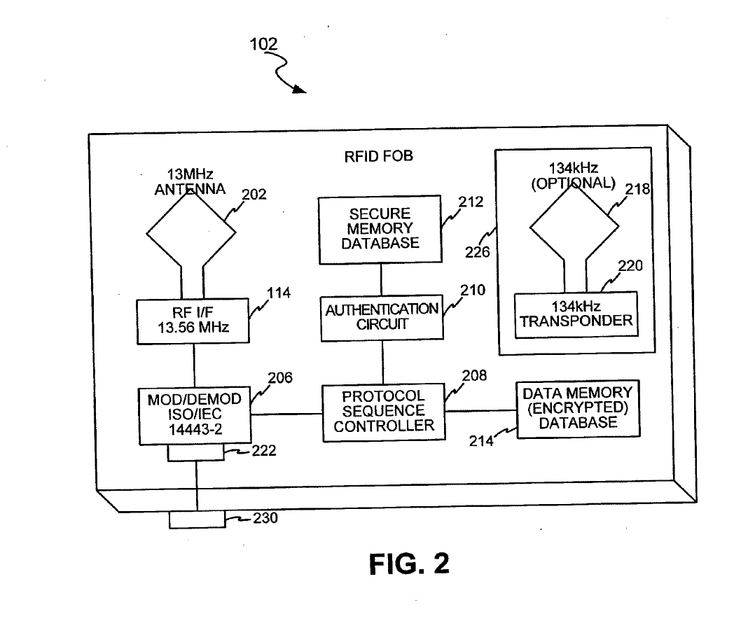

FIG. 2 illustrates a block diagram of the many functional blocks of an exemplary fob 102 in accordance with the present invention. Fob 102 may be a RFID fob 102 which may be presented by the user to facilitate an exchange of personal information such as medical information for facilitating healthcare services. As described herein, by way of example, fob 102 may be a RFID fob which may be presented for facilitating healthcare payment and/or services.

Fob 102 may include an antenna 202 for receiving an interrogation signal from RFID reader 104 via antenna 106 (or alternatively, via external antenna 108). Fob antenna 202 may be in communication with a transponder 114. In one exemplary embodiment, transponder 114 may be a 13.56 MHz transponder compliant with the ISO/IEC 14443 standard, and antenna 202 may be of the 13 MHz variety. The transponder 114 may be in communication with a transponder compatible modulator/demodulator 206 configured to receive the signal from transponder 114 and configured to modulate the signal into a format readable by any later connected circuitry. Further, modulator/demodulator 206 may be configured to format (e.g., demodulate) a signal received from the later connected circuitry in a format compatible with transponder 114 for transmitting to RFID reader 104 via antenna 202. For example, where transponder 114 is of the 13.56 MHz variety, modulator/demodulator 206 may be ISO/IEC 14443-2 compliant.

Modulator/demodulator 206 may be coupled to a protocol/sequence controller 208 for facilitating control of the authentication of the signal provided by RFID reader 104, and for facilitating control of the sending of fob 102 account number and/or other user information. In this regard, protocol/sequence controller 208 may be any suitable digital or logic driven circuitry capable of facilitating determination of the sequence of operation for fob 102 inner-circuitry. For example, protocol/sequence controller 208 may be configured to determine whether the signal provided by RFID reader 104 is authenticated, and thereby providing to RFID reader 104 the account number stored on fob 102.

Protocol/sequence controller 208 may be further in communication with authentication circuitry 210 for facilitating authentication of the signal provided by RFID reader 104. Authentication circuitry 210 may be further in communication with a non-volatile secure memory database 212. Secure memory database 212 may be any suitable elementary file system such as that defined by ISO/IEC 7816-4 or any other elementary file system allowing a lookup of data to be interpreted by the application on the chip.

Database 212 and any other database discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. In this regard, the data corresponding to the key field in each of the linked data tables may be preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, for example, storing individual files using an ISO/IEC 7816-4 file structure; implementing a domain whereby a dedicated file may be selected that exposes one or more elementary files containing one or more data sets; using data sets stored in individual files using a hierarchical filing system; data sets stored as records in a single file (for example, compression, SQL accessible, hashed via one or more keys, numeric, alphabetical by first tuple, etc.); block of binary (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats may be facilitated by storing the information as a Block of Binary (BLOB). Thus, any binary information may be stored in a storage space associated with a data set. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with a wide variety of system components by multiple and unrelated owners of the data sets. For example, a first data set which may be stored may be provided by a first issuer, a second data set which may be stored may be provided by an unrelated second issuer, and yet a third data set which may be stored, may be provided by a third issuer unrelated to the first and second issuer. Each of these three exemplary data sets may contain different information that may be stored using different data storage formats and/or techniques. Further, each data set may contain subsets of data which also may be distinct from other subsets.

Information may be stored, accessed, and/or transmitted on database 214 and/or any other database described herein. For example the present invention provides a system and method for a RF operable transaction instrument configured to manage multiple data sets (e.g., “application tenants”) of differing formats associated with a plurality of distinct transaction and/or healthcare account issuers. In this context, an “application tenant” may include all or any portion of any data sets which are substantially correlated to an account issuer, which the issuer may additionally use to substantially identify an instrument user or related account.

For example, where the account issuer provides application tenant information, the application tenant may include, for example, a healthcare identifier associated with a user enrolled in an issuer provided transaction account program, and all related subsets of data stored on fob 102. Where multiple application tenants are referred to herein, each tenant may constitute its own distinct data set, independent of any other application tenant data sets. For example, each application tenant may include a unique healthcare identifier and all associated subsets of data. Alternatively, an application tenant may include a healthcare identifier and an application for processing all data owned by an issuer. Thus, the data set or subset may include the processing application. Moreover, differing formats, as discussed herein, include differences in all or any portion of the formats. As such, “application tenant” and “distinct data set,” and data set “owner,” “healthcare issuer” and account “issuer” may be used interchangeably herein. Moreover, while reference may be made to healthcare, one skilled in the art will appreciate that the application similarly applies to other information.

As noted, in accordance with the invention, fob 102 is provided which permits the storage and presentment of at least one of a plurality of data sets for completing a transaction. The data sets may be stored on fob 102 itself, or on a remote database, as described below. The data sets stored with regard to fob 102 may be modified, deleted, added or augmented, as required by the healthcare issuer or the user. For example, as owner of the data, a healthcare issuer may modify a data set at the healthcare issuer's discretion. The healthcare issuer may modify the data, data subsets, member identifier and/or applications or data sets associated with its transaction account program. Such modifications may be completed or substantially completed in substantially real-time or at a later date, for example, when fob 102 is next presented.

In one exemplary embodiment, fob 102 itself is configured to store at least two data sets. In other exemplary embodiments, data sets may be stored in one or more databases and the data sets are affiliated with fob 102. For example, a central database on fob 102 may store multiple distinct data sets correlated with a unique healthcare provider. The data sets stored on the remote database may be stored thereon in such a manner as to mimic the corresponding data sets stored on fob 102. The multiple distinct data sets may be accessed, for example, by a healthcare system, whether stored on fob 102 or remote database stand alone device, and/or a computer user interface, via a network. In this example, fob 102 may include one or more user identifiers (e.g., insurance identifiers), which may be used to provide access to a subset of data included on fob 102.

Although all data sets associated with a particular fob 102 may be owned by the same owner, it is contemplated that in general, some of the data sets stored on fob 102 have different owners. Furthermore, the storage of data sets is configured to facilitate independent storage and management of the data sets on fob 102. Further still, the data sets may be stored in distinct differing formats provided by the distinct issuer or data set owner (also called “issuer” herein). The owners of data sets may include different individuals, entities, businesses, corporations, software, hardware, and/or the like. However, one skilled in the art will appreciate that the owners may also include different divisions or affiliates of the same corporation or entity.

A data set may contain any type of information stored in digital format. For example, a data set may include account numbers, programs/applications, scripts, cookies, instruments for accessing other data sets, and/or any other information.

As discussed above, many issuers of existing healthcare transaction instruments utilize predetermined formats for medical information, insurance numbers, account data, personal data and/or applications stored in association with fob 102. Similarly, the data storage media associated with these healthcare transaction instruments are typically configured to accommodate specific predetermined data formats. Thus, since the data format associated with a first issuer is often different from a data format of a second issuer, storage of multiple distinct data of differing formats on a single device provides complications for conventional systems. This is often true since, each issuer typically maintains an account processing system that uses a processing protocol different from other issuers, and the information stored on the transaction card relative to the issuer must be formatted accordingly. As such, to ensure the security and integrity of the issuer-owned data, the loading of data on fob 102 is typically performed by a healthcare provider, issuer or a third-party provider who typically uploads all related and similarly formatted data sets onto fob 102. However, since the third party may typically only be authorized by the issuer and/or healthcare provider to load issuer-owned data of similar format onto an issuer-provided fob 102, including differently formatted data sets on a single transaction device by the third party is often not permitted. More particularly, independent owners of data sets are often reluctant to conform their data set formats to a “standard format” because of the security advantages of maintaining a separate, distinct, often secreted format.

As stated above, in various embodiments of the present invention, the data may be stored without regard to a common format. However, in one exemplary embodiment of the present invention, the data set (e.g., BLOB) may be annotated in a standard manner when provided for manipulating the data onto the network. The annotation may comprise a short header, trailer, or other appropriate indicator related to each data set that may be configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set (e.g., LOADED, INITIALIZED, READY, BLOCKED, REMOVABLE, or DELETED). Subsequent bytes of data may be used to indicate for example, the identity of the user, user, account identifier or the like. Each of these condition annotations are further discussed herein.

The data may be used by protocol/sequence controller 208 for data analysis and used for management and control purposes, as well as security purposes. Authentication circuitry may authenticate the signal provided by RFID reader 104 by association of the RFID signal to authentication keys stored on database 212. Encryption circuitry may use keys stored on database 212 to perform encryption and/or decryption of signals sent to or from the RFID reader 104. Separate authentication keys may be used for each data set owner. The data set may consist of a directory file and/or an elementary file as defined in the ISO/IEC 7813 specification. A separate authentication key may be required to access the directory file and/or another key may be required for authentication to access the elementary file. The authentication keys may be supplemented with keys used to encrypt the data stored in the data set. The authentication and encryption keys may also be unique to the data set owner to prevent unauthorized access to the data. The RFID reader 104 and/or the terminal that is connected to the RFID reader 104 may contain the keys used to authenticate access to the data sets. The reader may also contain the encryption keys to decrypt the data in the data sets.

The data may be used by protocol/sequence controller 208 for data analysis and used for management and control purposes, as well as security purposes. Authentication circuitry may authenticate the signal provided by RFID reader 104 by association of the RFID signal to authentication keys stored on database 212. Encryption circuitry may use keys stored on database 212 to perform encryption and/or decryption of signals sent to or from RFID reader 104. For a basic introduction on cryptography, review a text written by Bruce Schneier entitled “Applied Cryptography: Protocols, Algorithms, and Source Code in C,” published by John Wiley & Sons (second edition, 1995), herein incorporated by reference.

In addition, protocol/sequence controller 208 may be in communication with a database 214 for storing at least fob 102 transponder account data, and a unique fob 102 identification code. Protocol/sequence controller 208 may be configured to retrieve the account identifier from database 214 as desired. Database 214 may be of the same configuration as database 212 described above. The fob transponder account data and/or unique fob identification code stored on database 214 may be encrypted prior to storage. Thus, where protocol/sequence controller 208 retrieves the account data, and or unique fob identification code from database 214, the transponder account identifier may be encrypted when being provided to RFID reader 104. Further, the data stored on database 214 may include, for example, an unencrypted unique fob 102 identification code, a user identification, Track 1 and Track 2 data, as well as specific application applets.

For example, in accordance with another exemplary embodiment, the account number may be stored in magnetic stripe format. That is, where the account number may be in magnetic stripe format, the account number portions are governed by the International Standards Organization ISO/IEC 7811, et al. standard, which are hereby incorporated by reference. The standard requires the magnetic stripe information to be encoded in three “tracks” (i.e., track 1, track 2, and track 3).

Data stored in track 1 may be typically used to verify the user's identity. Track 1 may be reserved for encoding the transaction account identifier, the name of the accountholder, and at least the expiration date of the transaction account or the transaction device. The information encoded in track 1 may be alphanumeric and may be encoded at about 7 Bits/Character. In an exemplary layout of the data stored in track 1, track 1 may be segmented into several distinct predetermined portions (e.g., “fields”) for encoding the various account identifying information. The following table may be useful for determining the field definitions of the information provided.

TABLE 1
Table of Field Codes for Track 1
SS = Start Sentinel “%”
FC = Format Code
PAN = Primary Acct. # (19 digits max)
FS = Field Separator “\hat{ }”
Name = 26 alphanumeric characters max.
Additional Data = Expiration Date, offset, encrypted PIN, etc.
ES = End Sentinel “?”
LRC = Longitudinal Redundancy Check

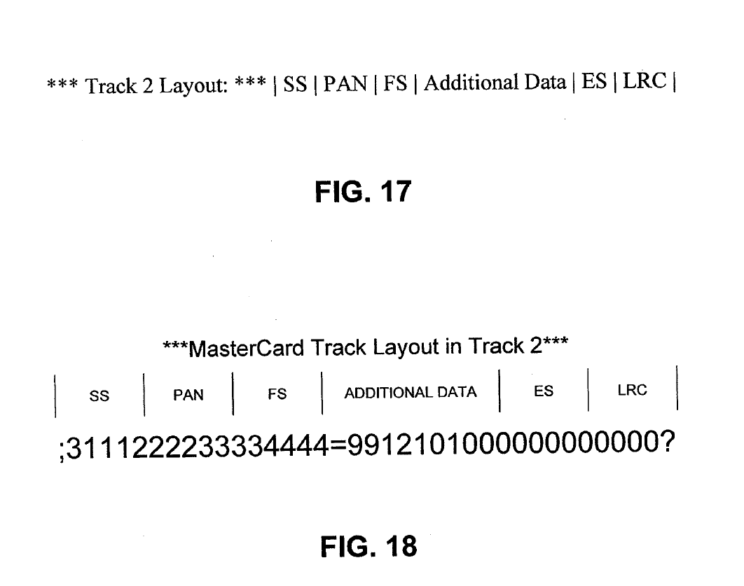

Track 2 may be the track most commonly used by the American Banking Association associated banking institutions. Track 2 may be typically reserved for a duplicate version of the transaction account identifier and the expiration date of the transaction account or the transaction device stored in track 1. In addition, track 2 may include an encrypted Personal Identification Code, and other discretionary data. However, the data in track 2 may be encoded at a lower Bit per Character density than the data encoded in track 1. The data in track 2 may be numeric only and may be encoded at about 5 Bits/Character. The lower density ratio in track 2 may be designed to ensure compatibility with older technology readers and to provide redundancy when reading with newer technology readers. FIG. 17 illustrates an exemplary layout of the data stored in track 2, wherein track 2 may be segmented into several distinct predetermined portions for encoding the various account identifying information. As shown, the following table may be useful for determining the definitions of the information provided.

TABLE 2
Table of Field Codes for Track 2
SS = Start Sentinel “%”
SS = Start Sentinel “;”
PAN = Primary Acct. # (19 digits max)
FS = Field Separator “=”
Additional Data = Expiration Date, offset, encrypted PIN, etc.
ES = End Sentinel “?”
LRC = Longitudinal Redundancy Check

Track 3 may be of similar description as Track 2. With the International Standards Organization adoption of standard ISO/IEC 4909, track 3 of the magnetic stripe format was no longer used by the banking industry. However, other transaction devices including a magnetic stripe, such as drivers licenses, use track 3, which may include both numeric only and alphanumeric characters. Track 3 may be unique in that track 3 was intended to have data read and WRITTEN on it. Cardholders would have account information UPDATED right on the magnetic stripe. The present invention anticipates that a fob user's travel-related information profile and/or account information may be updated using track 3. Unfortunately, track 3 may be almost an orphaned standard, since most readers currently in operation are not configured to write data from track 3. The original design of track 3 was to control off-line ATM transactions by recording transaction data for later reference by the banking institution. But since ATMs are now on-line, the usage of track 3 has been drastically reduced.

The most common technique used to encode data in magnetic stripe format may be known as Aiken Biphase, or ‘two-frequency coherent-phase encoding.’ The American National Standards Institute (ANSI) and the International Standards Organization (ISO) have chosen two standards to guide the encoding process. The ISO encoding protocol specifies that each of tracks 1, 2 and 3 must begin and end with a length of all Zero bits, called CLOCKING BITS. These are used to synch the self-clocking feature of bi-phase decoding. In addition, most transaction devices which use magnetic stripe encoding protocol use either the ANSI/ISO ALPHA Data format or the ANSI/ISO BCD Data format. For example, track 1 may be typically encoded in ANSI/ISO ALPHA Data format which may be a 7 bit, 6 data bits+1 parity bit (odd) format, where the data may be read least significant bit first. The ANSI/ISO ALPHA format character set contains 64 characters, 43 alphanumeric, 3 framing/field characters and 18 control/special characters. On the other hand, tracks 2 and 3 are typically encoded in ANSI/ISO BCD Data format, which may be a 5 bit, 4 data bits+1 parity bit(odd) format. The character set for the ANSI/ISO BCD Data format character set contains 16 characters, 10 alphanumeric, 3 framing/field characters and 3 control/special characters.

Ordinarily, a proxy account number (e.g., a portion of the transaction account number) includes essential identifying information, such as, for example, any information that may be common to the account provider. The common information (also called “common character,” herein) may include the account provider routing number, or common source indicator such as the character spaces reserved to indicate the identification of the issuing bank. Thus, where the proxy transaction account identifier corresponds to an American Express account, the proxy transaction account identifier may include the common prefix number 3715, encoded the field location where such common character may be ordinarily encoded in traditional magnetic stripe format. The prefix 3715 is an example of the required set of digits in the account number required to identify the issuer as American Express. Each credit card issuer has a unique set of digits commonly agreed upon between institutions that identifies the issuer.

FIG. 18 illustrates the encoding of which would ordinarily be done by an entity, such as, for example, MasterCard in track 2 format. FIG. 18 shows the encoding of a MasterCard account number 3111 2222 3333 4444 with expiration date 12/99 in traditional track 1 format. Since MasterCard uses the number 3111 to identify its transaction accounts, the proxy account identifier may also use the number 3111 so that the receiving system (e.g., RFID reader 104 or merchant system 130, or account provider) further recognizes that the proxy account identifier may be from a MasterCard transaction device. It should be noted that in this example, the “3” and the “101” may be common characters to all MasterCard transaction accounts. For a more detailed explanation of magnetic stripe format data exchange, see U.S. patent application Ser. No. 10/810,473, filed Mar. 26, 2004, entitled “SYSTEM AND METHOD FOR ENCODING INFORMATION IN MAGNETIC STRIPE FORMAT FOR USE IN RADIO FREQUENCY IDENTIFICATION TRANSACTIONS,” incorporated herein by reference.

Fob 102 may be configured to respond to multiple interrogation frequency transmissions provided by RFID reader 104. That is, as described more fully below, RFID reader 104 may provide more than one RF interrogation signal. In this case, fob 102 may be configured to respond to the multiple frequencies by including in fob 102 one or more additional RF signal receiving/transmitting units 226. RF signal receiving/transmitting unit 226 may include an antenna 218 and transponder 220 where the antenna 218 and transponder 220 are compatible with at least one of the additional RF signals provided by RFID reader 104. For example, in one exemplary embodiment, fob 102 may include a 134 KHz antenna 218 configured to communicate with a 134 KHz transponder 220. In this exemplary configuration, an ISO/IEC 14443-2 compliant modulator/demodulator may not be required. Instead, the 134 KHz transponder may be configured to communicate directly with the protocol/sequence controller 208 for transmission and receipt of authentication and account number signals as described above.

In another embodiment, fob 102 may further include a universal serial bus (USB) connector 132 for interfacing fob 102 to a user interface 134. User interface 134 may be further in communication with a POI device 110 via a network 136. Network 136 may be the Internet, an intranet, or the like as is described above with respect to network 112. Further, the user interface 134 may be similar in construction to any conventional input devices and/or computing systems aforementioned for permitting the system user to interact with the system. In one exemplary embodiment, fob 102 may be configured to facilitate online Internet payments. A USB converter 222 may be in communication with a USB connector 232 for facilitating the transfer of information between the modulator/demodulator 206 and USB connector 132. Alternatively, USB converter 222 may be in communication with protocol/sequence controller 208 to facilitate the transfer of information between protocol/sequence controller 208 and USB connector 132.

Where fob 102 includes a USB connector 132, fob 102 may be in communication with, for example, a USB port on user interface 134. The information retrieved from fob 102 may be compatible with credit card and/or smart card technology enabling usage of interactive applications on the Internet. No RFID reader may be required in this embodiment since the connection to POI device 110 may be made using a USB port on user interface 134 and a network 136.

Fob 102 may include means for enabling activation of the fob by the user. In one exemplary embodiment, a switch 230 which may be operated by the user of fob 102. The switch 230 on fob 102 may be used to selectively or inclusively activate fob 102 for particular uses. In this context, the term “selectively” may mean that switch 230 enables the user to place fob 102 in a particular operational mode. For example, the user may place fob 102 in a mode for enabling purchase of a good or of a service using a selected account number. Alternatively, the fob may be placed in a mode as such that the fob account number is provided by USB port 132 (or serial port) only and fob transponder 114 is disabled. In addition, the term “inclusively” may mean that fob 102 is placed in an operational mode permitting fob 102 to be responsive to the RF interrogation and interrogation via the USB connector 132. In one particular embodiment, switch 230 may remain in an OFF position ensuring that one or more applications or accounts associated with fob 102 are non-reactive to any commands issued by RFID reader 104. As used herein, the OFF position may be termed the “normal” position of activation switch 230, although other normal positions are contemplated.

In another exemplary embodiment, when switch 230 is moved from the OFF position, fob 102 may be deemed activated by the user. That is, switch 230 may activate internal circuitry in fob 102 for permitting the fob to be responsive to RF signals (e.g., commands from RFID reader 104). In this way, switch 230 may facilitate control of the active and inactive states of fob 102. Such control increases the system security by preventing inadvertent or illegal use of fob 102.

In one exemplary embodiment, switch 230 may be a simple mechanical device in communication with circuitry which may electrically prevent the fob from being powered by a RFID reader. That is, when switch 230 is in its normal position, switch 230 may provide a short to fob 102 internal circuitry, preventing fob 102 from being responsive to interrogation by RF or via the USB connector 132. In this arrangement, switch 230 may be, for example, a “normally closed” (NC) configured switch, which may be electrically connected to antenna 202 at the interface of antenna 202 and transponder 114. Switch 230 may be depressed, which may open switch 230 fully activating antenna 202.

In yet another exemplary embodiment, fob 102 may include a biometric sensor and biometric membrane configured to operate as switch 230 and activate fob 102 when provided biometric signal from fob 102 user. Such biometric signal may be the digital reading of a fingerprint, thumbprint, or the like. Typically, where biometric circuitry is used, the biometric circuitry may be powered by an internal voltage source (e.g., battery). In this case, the switch may not be a simple mechanical device, but a switch which is powered. In yet another exemplary embodiment, switch 230 may be battery powered though no biometric circuitry is present in fob 102.

In yet another embodiment, switch 230 may be a logic switch. Where switch 230 is a logic switch 230 control software may be read from sequence controller 208 to selectively control the activation of the various fob 102 components.

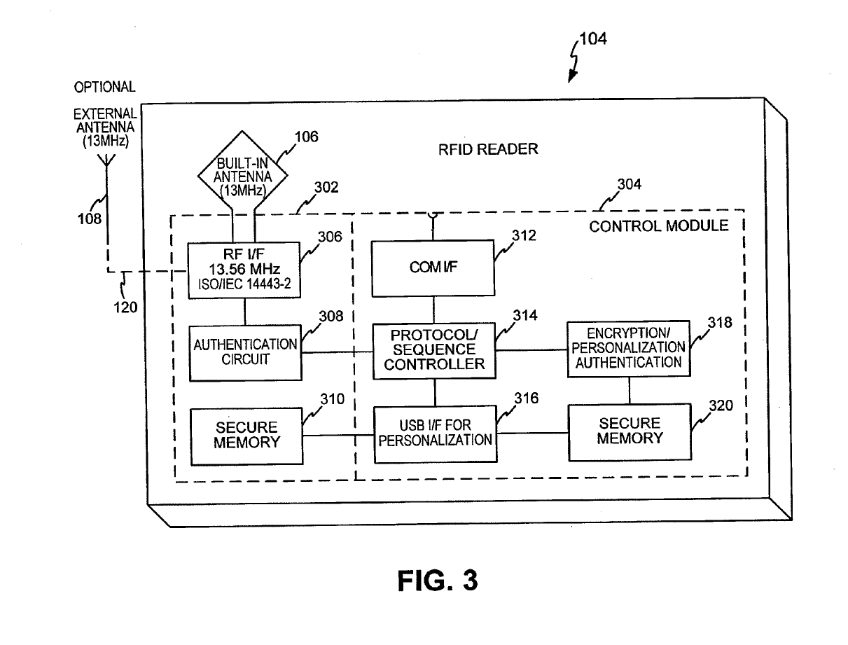

FIG. 3 illustrates an exemplary block diagram of RFID reader 104 in accordance with an exemplary embodiment of the present invention. RFID reader 104 includes, for example, an antenna 106 coupled to a RF module 302, which is further coupled to a control module 304. In addition, RFID reader 104 may include an antenna 108 positioned remotely from RFID reader 104 and coupled to RFID reader 104 via a suitable cable 120, or other wire or wireless connection.

RF module 302 and antenna 106 may be suitably configured to facilitate communication with fob 102. Where fob 102 is formatted to receive a signal at a particular RF frequency, RF module 302 may be configured to provide an interrogation signal at that same frequency. For example, in one exemplary embodiment, fob 102 may be configured to respond to an interrogation signal of about 13.56 MHz. In this case, RFID antenna 106 may be 13 MHz and may be configured to transmit an interrogation signal of about 13.56 MHz. That is, fob 102 may be configured to include a first and second RF module (e.g., transponder) where the first module may operate using a 134 kHz frequency and the second RF module may operate using a 13.56 MHz frequency. RFID reader 104 may include two receivers which may operate using the 134 kHz frequency, the 13.56 MHz frequency or both. When RFID reader 104 is operating at 134 kHz frequency, only operation with the 134 kHz module on fob 102 may be possible. When RFID reader 104 is operating at the 13.56 MHz frequency, only operation with the 13.56 MHz module on fob 102 may be possible. Where RFID reader 104 supports both a 134 kHz frequency and a 13.56 MHz RF module, fob 102 may receive both signals from RFID reader 104. In this case, fob 102 may be configured to prioritize selection of the one or the other frequency and reject the remaining frequency. Alternatively, RFID reader 104 may receive signals at both frequencies from fob 102 upon interrogation. In this case, RFID reader 104 may be configured to prioritize selection of one or the other frequency and reject the remaining frequency.

Further, a protocol/sequence controller 314 may include an optional feedback function for notifying the user of the status of a particular healthcare information transaction. For example, the optional feedback may be in the form of an LED, LED screen and/or other visual display which is configured to light up or display a static, scrolling, flashing and/or other message and/or signal to inform a user using fob 102 that a healthcare information transaction is initiated (e.g., fob is being interrogated), the fob is valid (e.g., fob is authenticated), a healthcare information transaction is being processed, (e.g., fob transponder account identifier is being read by RFID reader 104) and/or the transaction is accepted or denied (e.g., account identifiers approved or disapproved). Such an optional feedback may or may not be accompanied by an audible indicator (or may present the audible indicator singly) for informing fob 102 user of the healthcare information transaction status. The audible feedback may be a simple tone, multiple tones, musical indicator, and/or voice indicator configured to signify when fob 102 is being interrogated, the healthcare information transaction status, or the like.

RFID antenna 106 may be in communication with a transponder 306 for transmitting an interrogation signal and receiving at least one of an authentication request signal and/or an account data from fob 102. Transponder 306 may be of similar description as transponder 114 of FIG. 2. In particular, transponder 306 may be configured to send and/or receive RF signals in a format compatible with antenna 106 in similar manner as was described with respect to fob transponder 114. For example, where transponder 306 is 13.56 MHz RF rated antenna 106 may be 13.56 MHz compatible. Similarly, where transponder 306 is ISO/IEC 14443 rated, antenna 106 may be ISO/IEC 14443 compatible.

RF module 302 may include, for example, transponder 306 in communication with authentication circuitry 308 which may be in communication with a secure database 310. Authentication circuitry 308 and database 310 may be of similar description and operation as described with respect to authentication circuitry 210 and secure memory database 212 of FIG. 2. For example, database 310 may store data corresponding to fob 102 which may be used to authorize the tracking of user performance over system 100. Database 310 may additionally store RFID reader 104 identifying information and/or provide such information to fob 102 for use in authenticating whether RFID reader 104 is authorized to be provided the fob transponder account identifier stored on fob database 214.

Authentication circuitry 308 may be of similar description and operation as authentication circuitry 210. That is, authentication circuitry 308 may be configured to authenticate the signal provided by fob 102 in a similar manner that authentication circuitry 210 may be configured to authenticate the signal provided by RFID reader 104. As is described more fully below, fob 102 and RFID reader 104 engage in mutual authentication. In this context, “mutual authentication” may mean that operation of the system 100 may not take place until fob 102 authenticates the signal from RFID reader 104, and RFID reader 104 authenticates the signal from fob 102.

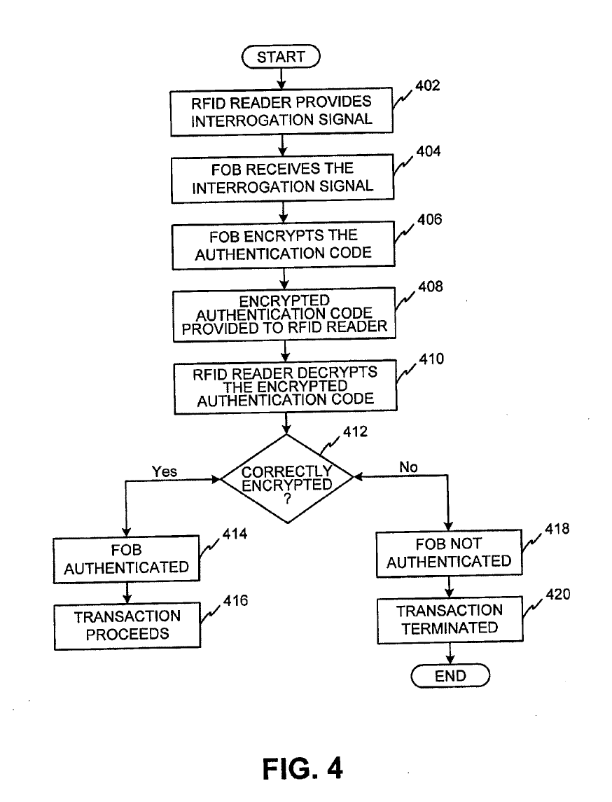

FIG. 4 depicts a flowchart of an exemplary authentication process in accordance with the present invention. The authentication process is depicted as one-sided. That is, the flowchart depicts the process of RFID reader 104 authenticating fob 102, although similar steps may be followed in the instance that fob 102 authenticates RFID reader 104.

As noted, database 212 may store security keys for encrypting or decrypting signals received from RFID reader 104. In an exemplary authentication process, where RFID reader 104 is authenticating fob 102, RFID reader 104 may provide an interrogation signal to fob 102 (step 402). The interrogation signal may include a random code generated by the RFID reader authentication circuit 210, which is provided to fob 102 and which is encrypted using an unique encryption key corresponding to the unique fob 102 identification code. For example, protocol/sequence controller 314 may provide a command to activate the authentication circuitry 308. Authentication circuitry 308 may provide from database 310 a fob interrogation signal including a random number as a part of the authentication code generated for each authentication signal. The authentication code may be an alphanumeric code which is recognizable (e.g., readable) by RFID reader 104 and fob 102. The authentication code may be provided to fob 102 via the RFID RF interface 306 and antenna 106 (or alternatively antenna 108).

Fob 102 receives the interrogation signal (step 404). The interrogation signal including the authorization code may be received at RF interface 114 via antenna 202. Once fob 102 is activated, the interrogation signal including the authorization code may be provided to the modulator/demodulator circuit 206 where the signal may be demodulated prior to providing the signal to protocol/sequence controller 208. Protocol/sequence controller 208 may recognize the interrogation signal as a request for authentication of fob 102, and provide the authentication code to authentication circuit 210. Fob 102 may then encrypt the authentication code (step 406). In particular, encryption may be done by authentication circuit 210, which may receive the authentication code and encrypt the code prior to providing the encrypted authentication code to protocol/sequence controller 208. Fob 102 may then provide the encrypted authentication code to RFID reader 104 (step 408). That is, the encrypted authentication code may be provided to RFID reader 104 via modulator/demodulator circuit 206, RF interface 114 (e.g., transponder 114) and antenna 106.

RFID reader 104 may then receive the encrypted authentication code and decrypt it (step 410). That is, the encrypted authentication code may be received at antenna 106 and RF interface 306 and may be provided to authentication circuit 308. Authentication circuit 308 may be provided a security authentication key (e.g., transponder system decryption key) from database 310. The authentication circuit may use the authentication key to decrypt (e.g., unlock) the encrypted authorization code. The authentication key may be provided to the authentication circuit based on the unique fob 102 identification code. For example, the encrypted authentication code may be provided along with the unique fob 102 identification code. The authentication circuit may receive the unique fob 102 identification code and retrieve from database 310 a transponder system decryption key correlative to the unique fob 102 identification code for use in decrypting the encrypted authentication code.

Once the authentication code is decrypted, the decrypted authentication code is compared to the authentication code provided by RFID reader 104 at step 402 (step 412) to verify its authenticity. If the decrypted authorization code is not readable (e.g., recognizable) by the authentication circuit 308, fob 102 is deemed to be unauthorized (e.g., unverified) (step 418) and the operation of system 100 is terminated (step 420). Contrarily, if the decrypted authorization code is recognizable (e.g., verified) by fob 102, the decrypted authorization code is deemed to be authenticated (step 414), and the transaction is allowed to proceed (step 416). In one particular embodiment, the proceeding transaction may mean that fob 102 may authenticate RFID reader 104 prior to RFID reader 104 authenticating fob 102, although, it should be apparent that RFID reader 104 may authenticate fob 102 prior to fob 102 authenticating RFID reader 104.

It should be noted that in an exemplary verification process, authorization circuit 308 may determine whether the unlocked authorization code is identical to the authorization code provided in step 402. If the codes are not identical then fob 102 is not authorized to access system 100. Although, the verification process is described with respect to identicality, identicality is not required. For example, authentication circuit 308 may verify the decrypted code through any protocol, steps, or process for determining whether the decrypted code corresponds to authorized fob 102.

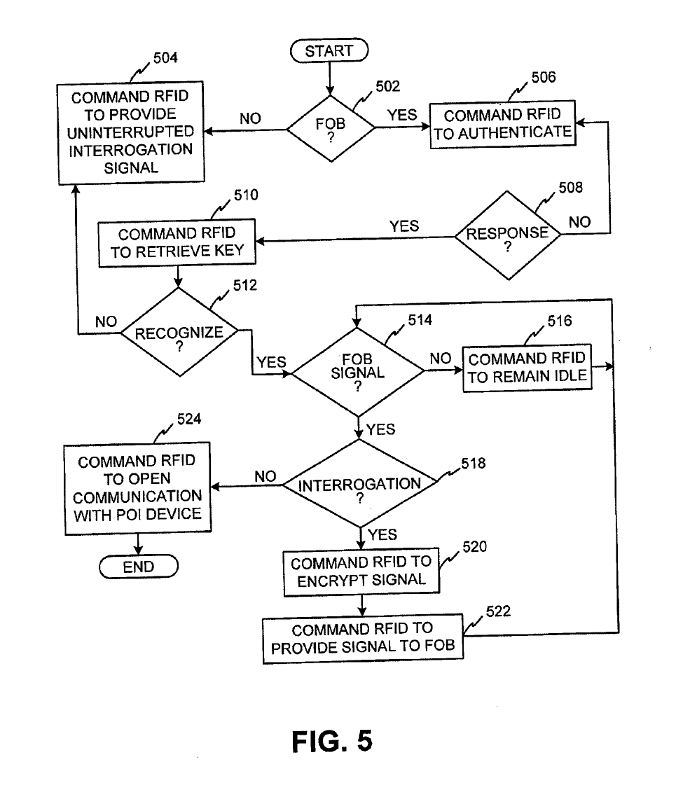

Authentication circuitry 308 may additionally be in communication with protocol/sequence controller 314 of similar operation and description as protocol/sequence controller 208 of FIG. 2. That is, protocol/sequence device controller 314 may be configured to determine the order of operation of RFID reader 104 components. For example, FIG. 5 illustrates an exemplary decision process under which protocol/sequence controller 314 may operate. Protocol/sequence controller 314 may command the different components of RFID reader 104 based on whether fob 102 is present (step 502). For example, if fob 102 is not present, then protocol/sequence controller 314 may command RFID reader 104 to provide an uninterrupted interrogation signal (step 504). That is, protocol/sequence controller 314 may command authentication circuit 308 to provide an uninterrupted interrogation signal until the presence of fob 102 is realized. If fob 102 is present, the protocol/sequence controller 314 may command RFID reader 104 to authenticate fob 102 (step 506).

As noted above, authentication may mean that protocol/sequence controller 314 may command authentication circuit 308 to provide fob 102 with an authorization code. If a response is received from fob 102, protocol/sequence controller may determine if the response is a response to RFID reader 104 provided authentication code, or if the response is a signal requiring authentication (step 508). If the signal requires authentication, then protocol/sequence controller 314 may activate the authentication circuit as described above (step 506). On the other hand, if fob 102 signal is a response to the provided authentication code, then protocol/sequence controller 314 may command RFID reader 104 to retrieve the appropriate security key for enabling recognition of the signal (step 510). That is, protocol/sequence controller 314 may command authentication circuit 308 to retrieve from database 310 a security key (e.g., transponder system decryption key), unlock the signal, and compare the signal to the signal provided by RFID reader 104 in the authentication process (e.g., step 506). If the signal is recognized, protocol/sequence controller 314 may determine that fob 102 is authorized to access system 100. If the signal is not recognized, then fob 102 is considered not authorized (step 512), in which case, protocol/sequence controller 314 may command the RFID controller to interrogate for authorized fobs (step 504).

Once protocol/sequence controller 314 determines that fob 102 is authorized, protocol/sequence controller 314 may seek to determine if additional signals are being sent by fob 102 (step 514). If no additional signal is provided by fob 102, then protocol/sequence controller 314 may provide all the components of RFID reader 104 to remain idle until such time as a signal is provided (step 516). Contrarily, where an additional fob 102 signal is provided, protocol/sequence controller 314 may determine if fob 102 is requesting access to engine 130 POI terminal 110 or if fob 102 is attempting to interrogate RFID reader 104 for return (e.g., mutual) authorization (step 518). Where fob 102 is requesting access to engine 130 POI terminal 110, protocol/sequence controller 314 may command RFID reader 104 to open communications with POI terminal 110 (step 524). In particular, protocol/sequence controller 314 may command POI terminal communications interface 312 to become active, permitting transfer of data between RFID reader 104, engine 130, and POI terminal 110.

On the other hand, if protocol/sequence controller 314 determines that fob 102 signal is a mutual interrogation signal, then protocol/sequence controller 314 may command RFID reader 104 to encrypt the signal (step 520). Protocol/sequence controller 314 may command encryption authentication circuit 318 to retrieve from database 320 the appropriate encryption key in response to fob 102 mutual interrogation signal. Protocol/sequence controller 314 may then command RFID reader 104 to provide the encrypted mutual interrogation signal to fob 102. Protocol/sequence controller 314 may command authentication circuit 318 to provide an encrypted mutual interrogation signal for fob 102 to mutually authenticate (step 522). Fob 102 may then receive the encrypted mutual interrogation signal and retrieve from authentication circuitry 212 a RFID reader 104 decryption key.

Although an exemplary decision process of protocol/sequence controller 314 is described, it should be understood that a similar decision process may be undertaken by protocol/sequence controller 208 in controlling the components of fob 102. Indeed, as described above, protocol/sequence controller 314 may have similar operation and design as protocol/sequence controller 208. In addition to the above, protocol/sequence controllers 208 and 314 may incorporate in the decision process appropriate commands for enabling USB interfaces 222 and 316, when the corresponding device is so connected.

Encryption/decryption component 318 may be further in communication with a secure account identifier database 320 which stores the security keys necessary for decrypting the encrypted fob account identifier. Upon appropriate request from protocol/sequence controller 314, encryption/decryption component (e.g., circuitry 318) may retrieve the appropriate security key, decrypt the fob account identifier and forward the decrypted account identifier to protocol/sequence controller 314 in any format readable by any later connected POI terminal 110. In one exemplary embodiment, the account identifier may be forwarded in a conventional magnetic stripe card format compatible with the ISO/IEC 7813 standard. That is, in accordance with the invention, there is no need to translate or correlate the account identifier to traditional magnetic stripe format as is done with the prior art. The invention processes the user and/or healthcare information request directly, as if the card associated with the account has been presented for storing user and/or healthcare information.

Upon receiving the account identifier in magnetic stripe format, protocol/sequence controller 314 may forward the account identifier to POI terminal 110 via communications interface 312 and data link 122, as best shown in FIG. 1A. POI terminal 110 may receive the decrypted account identifier and forward the magnetic stripe formatted account identifier to host network 112 for processing under the employer's business as usual standard. In this way, the present invention eliminates the need of a third-party server. Further, where POI terminal 110 receives a response from host network 112 (e.g., healthcare information authorized or denied), protocol/sequence controller 314 may provide the network response to RF module 302 for optically and/or audibly communicating the response to fob 102 user.

RFID reader 104 may additionally include USB interface 316, in communication with the protocol/sequence controller 314. In one embodiment, the USB interface may be a RS22 serial data interface. Alternatively, RFID reader 104 may include a serial interface such as, for example, a RS232 interface in communication with protocol/sequence controller 314. USB connector 316 may be in communication with a personalization system 116 (shown in FIG. 1B) for initializing RFID reader 104 to system 100 application parameters. That is, prior to operation of system 100, RFID reader 104 may be in communication with personalization system 116 for populating database 310 with a listing of security keys belonging to authorized fobs 102, and for populating database 320 with the security keys to decrypt fob 102 account identifiers placing the account identifiers in ISO/IEC 7813 format. In this way, RFID reader 104 may be populated with a unique identifier (e.g., serial number) which may be used by fob authentication circuitry 210 to determine if RFID reader 104 is authorized to receive fob 102 encrypted account identifier.

FIG. 1B illustrates an exemplary personalization system 100B, in accordance with the present invention. In general, typical personalization system 100B may be any system for initializing RFID reader 104 and fob 102 for use in system 100A. With reference to FIG. 1B, the similar personalization process for fob 102 may be illustrated. For example, personalization system 116 may be in communication with fob 102 via RF ISO 14443 interface 114 for populating fob database 212 with the security keys for facilitating authentication of the unique RFID reader 104 identifier. In addition, personalization system 116 may populate on database 212 a unique fob 102 identifier for use by RFID reader 104 in determining whether fob 102 is authorized to access system 100. Personalization system 116 may populate (e.g., inject) the encrypted fob 102 account identifier into fob database 214 for later providing to an authenticated RFID reader 104.

In one exemplary embodiment, personalization system 116 may include any standard computing system as described above. For example, personalization system 116 may include a standard personal computer containing a hardware security module operable using any conventional graphic user interface. Prior to populating the security key information account identifier and unique identifying information into fob 102 or RFID reader 104, the hardware security module may authenticate fob 102 and RFID reader 104 to verify that the components are authorized to receive the secure information.

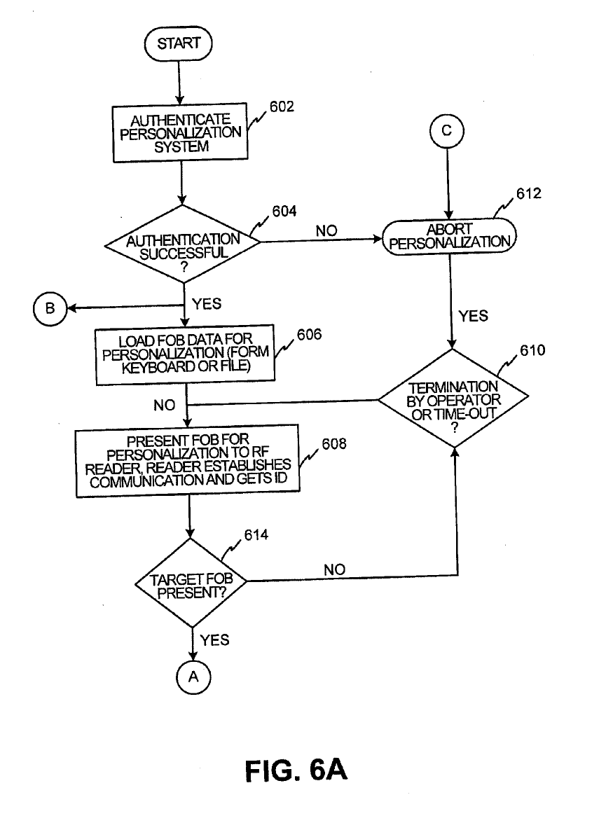

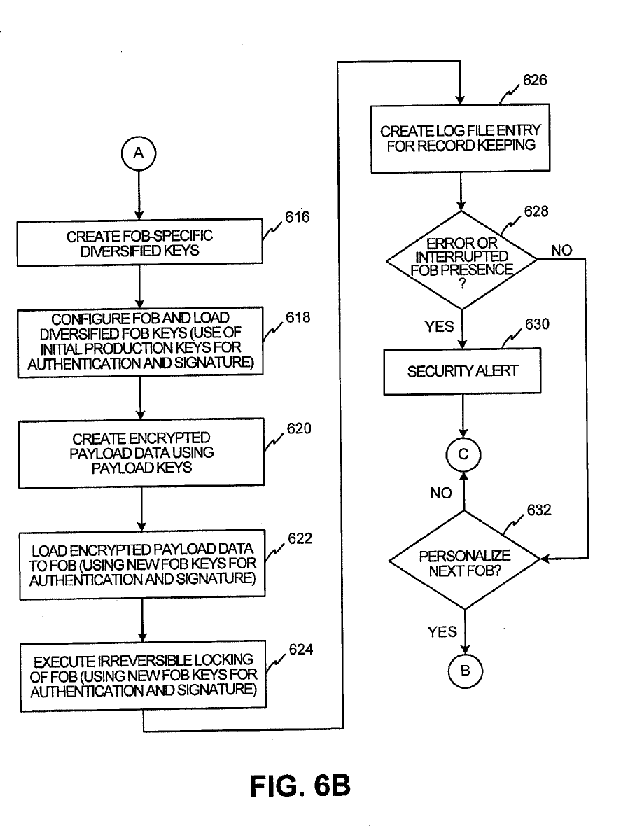

FIGS. 6A-B illustrate an exemplary flowchart of a personalization procedure which may be used to personalize fob 102 and/or RFID reader 104. Although the following description discusses mainly personalization of fob 102, RFID reader 104 may be personalized using a similar process. The personalization process, which occurs between personalization system 116 and the device to be personalized (e.g., fob 102 or RFID reader 104), may begin, for example at step 602. Mutual authentication may occur between personalization system 116 and the device to be authenticated in much the same manner as was described above with regard to fob 102 mutually authenticating with RFID reader 104. That is, personalization system 116 may transmit a personalization system 116 identifier to the device to be authenticated which is compared by the device authentication circuitry 210, 308 against personalization system identifiers stored in the device database 212, 310. Where a match does not occur (step 604), the personalization process may be aborted (step 612). Where a match occurs (step 604), personalization system 116 may prepare a personalization file to be provided to the device to be personalized (step 606). If personalization system 116 is operated manually, the personalization file may be entered into personalization system 116 using any suitable system interface such as, for example, a keyboard (step 606). Where personalization system 116 operator elects to delay the preparation of the personalization files, personalization system 116 may abort the personalization process (step 610). In this context, the personalization file may include the unique fob 102 or RFID reader 104 identifier, security key for loading into database 212 and 310, and/or security keys for decrypting a fob transponder account identifier which may be loaded in database 320.

Fob 102 may be personalized by direct connection to personalization system 116 via RF ISO/IEC 14443 interface 114, or fob 102 may be personalized using RFID reader 104. Personalization system 116 and RFID reader 104 may engage in mutual authentication and RFID reader 104 may be configured to transmit the fob personalization file to fob 102 via RF. Once fob 102 is presented to RFID reader 104 (steps 608, 614) for personalization, fob 102 and RFID reader 104 may engage in mutual authentication (step 614). Where fob 102 is not presented to RFID reader 104 for personalization, the personalization process may be terminated (step 610).

If fob 102 is detected, personalization system 116 may create as a part of the personalization file, a unique identifier for providing to fob 102 (step 616). The identifier is unique in that one identifier may be given only to a single fob. That is, no other fob may have that same identifier. Fob 102 may then be configured and loaded with that identifier (step 618).

The encrypted fob 102 transponder account identifier may be populated into fob 102 in the same manner as is described with respect to the unique fob 102 identifier. That is, personalization system 116 may pre-encrypt the account data (step 620) and inject the encrypted account into fob database 214 (step 622). The encrypted account data may be loaded (e.g., injected) into fob 102 using RFID reader 104 as discussed above.

Once the personalization file is populated into fob 102, the populated information is irreversibly locked to prevent alteration, unauthorized reading and/or unauthorized access (step 624). Personalization system 116 may then create a log of the personalization file information for later access and analysis by the personalization system 116 resource (step 626).

It should be noted that in the event the personalization process is compromised or interrupted (step 628), personalization system 116 may send a security alert to the user (step 630) and the personalization process may be aborted (step 612). On the other hand, where no such compromising or interruption exists, personalization system 116 may be prepared to begin initialization on a second device to be personalized (step 632).

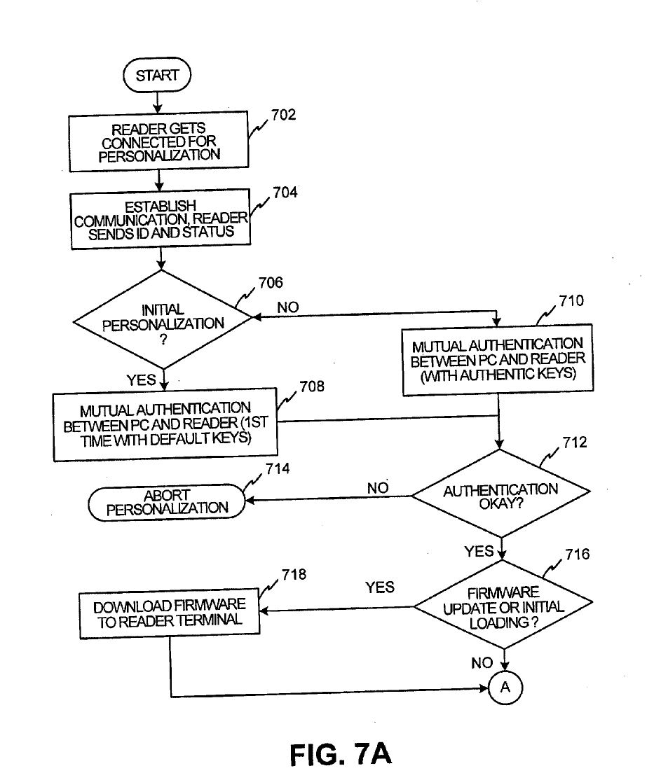

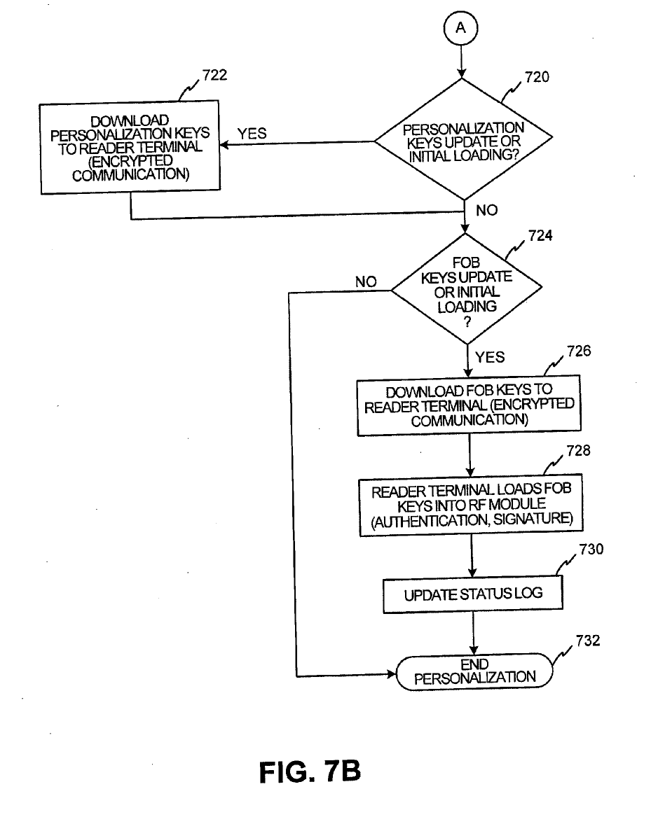

FIGS. 7A-B illustrate another exemplary embodiment of a personalization process which may be used to personalize RFID reader 104. RFID reader 104 may be in communication with personalization system 116 via RFID reader USB connection 316 (step 702). Once connected, personalization system 116 may establish communications with RFID reader 104 and RFID reader 104 may provide personalization system 116 any RFID reader 104 identification data presently stored on RFID reader 104 (step 704). In accordance with step 708, where RFID reader 104 is being personalized for the first time (step. 706), RFID reader 104 and personalization system 116 may engage in mutual authentication as described above with respect to FIGS. 6A-B. After the mutual authentication is complete, personalization system 116 may verify that RFID reader 104 is properly manufactured or configured to operate within system 100A. The verification may include evaluating the operation of RFID reader 104 by determining if the RFID reader will accept predetermined default settings. That is, personalization system 116 may then provide RFID reader 104 a set of default settings (step 708) and determine if RFID reader 104 accepts those settings (step 712). If RFID reader 104 does not accept the default settings, personalization system 116 may abort the personalization process (step 714).

If the personalization system 116 determines that the personalization process is not the first personalization process undertaken by RFID reader 104 (step 706), personalization system 116 and RFID reader 104 may engage in a mutual authentication process using the existing security keys already stored on RFID reader 104 (step 710). If authentication is unsuccessful (step 712), personalization system 116 may abort the personalization process (step 714).

Where personalization system 116 and RFID reader 104 successfully mutually authenticate, personalization system 116 may update RFID reader 104 security keys (step 716). Updating the security keys may take place at any time as determined by a system 100 manager. The updating may take place as part of a routine maintenance or merely to install current security key data. The updating may be performed by downloading firmware into RFID reader 104 (step 718). In the event that personalization system 116 determines in step 706 that RFID reader 104 is undergoing an initial personalization, the firmware may be loaded into RFID reader 104 for the first time. In this context, “firmware” may include any file which enables the RFID reader 104 to operate under system 100 guidelines. For example, such guidelines may be directed toward the operation of RFID reader protocol/sequence controller 314.

Personalization system 116 may then determine if the personalization keys (e.g., security keys, decryption keys, RFID identifier) need to be updated or if RFID reader 104 needs to have an initial installation of the personalization keys (step 720). If so, then personalization system 116 may download the personalization keys as appropriate (step 722).

Personalization system 116 may then check RFID reader 104 to determine if fob 102 identifiers and corresponding security keys should be updated or initially loaded (step 724). If no updating is necessary personalization system 116 may end the personalization procedure (step 732). Contrarily, if personalization system 116 determines that fob 102 identifiers and corresponding keys need to be updated or installed, personalization system 116 may download the information onto RFID reader 104 (step 726). The information (e.g., fob security keys and identifiers) may be downloaded in an encrypted format and RFID reader 104 may store the information in RFID reader database 310 as appropriate (step 728). Personalization system 116 may then create or update a status log cataloging for later use and analysis by personalization system 116 user (step 730). Upon updating the status log, the personalization process may be terminated (step 732).

It should be noted that, in some instances it may be necessary to repersonalize the RFID reader in similar manner as described above. In that instance, the personalization process described in FIGS. 7A and 7B may be repeated.

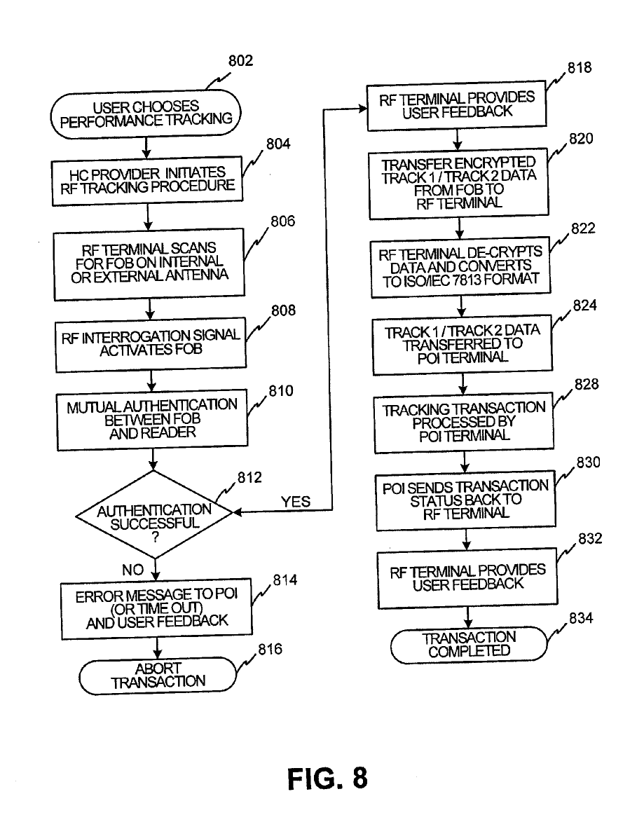

FIG. 8 illustrates an exemplary flow diagram for the operation of system 100A. The operation may be understood with reference to FIG. 1A, which depicts the elements of system 100A which may be used in an exemplary transaction. The process is initiated when a user desires to present fob 102 for storing and/or accessing user information such as healthcare information (step 802). Upon presentation of fob 102, a healthcare provider initiates the RF healthcare information transaction via RFID reader 104 (step 804). In particular, RFID reader 104 sends out an interrogation signal to scan for the presence of fob 102 (step 806). The RF signal may be provided via RFID reader antenna 106 or optionally via external antenna 108. The RF interrogation signal then activates fob 102 (step 808).

Fob 102 and RFID reader 104 may then engage in mutual authentication (step 810). Where the mutual authentication is unsuccessful, an error message may be provided to the user via the RFID optical and/or audible indicator (step 814) and the healthcare information transaction may be aborted (step 816). Where the mutual authentication is successful (step 812), a transaction will be initiated. That is, RFID reader 104 may provide the user with an appropriate optical and/or audible message (e.g., “healthcare information processing” or “wait”) (step 818). Fob protocol/sequence controller 208 may then retrieve from database 214 an encrypted fob account identifier and provide the encrypted account identifier to RFID reader 104 (step 820).

RFID reader 104 may then decrypt the account identifier and convert the account identifier into magnetic stripe (ISO/IEC 7813) format (step 822) and provide the unencrypted account identifier to engine 130 (step 824). In particular, the account identifier may be provided to POI terminal 110 for transmission to host network 112 for processing (step 828). Processing healthcare information will be discussed in greater detail herein. Upon processing, POI terminal 110 may then send an optical and/or audible healthcare information transaction status message to RFID reader 104 (step 830) for communication to the user (step 832). Once the user receives the status message, the transaction is completed (step 834.)

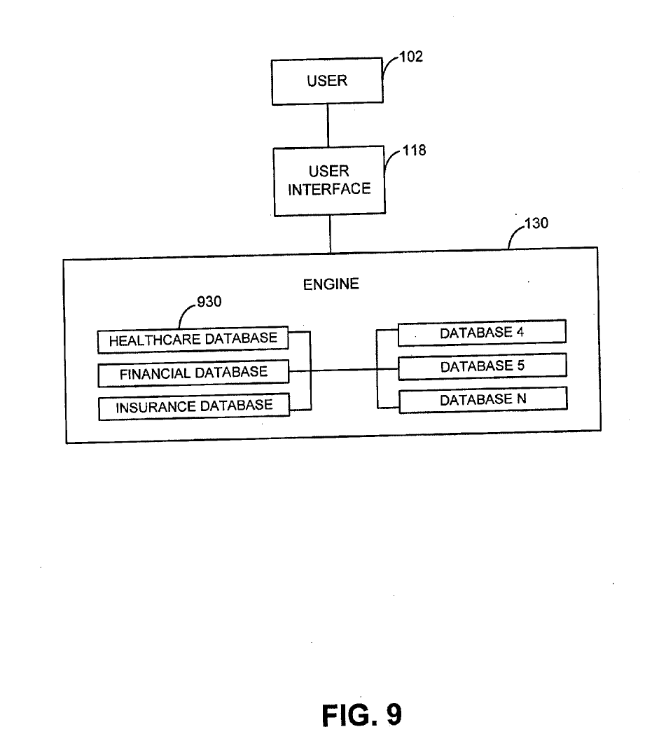

Processing user information may be achieved by several methods and systems. For example, in accordance with another aspect of the present invention, and with reference to FIG. 9, user 102 may access a remote personal information engine 130 through user interface 118 to facilitate the managing, storing, accessing, and/or other manipulation of user information such as healthcare information.

More particularly, engine 130 may comprise a variety of subprograms and/or databases that facilitate managing, storing, accessing, and/or other manipulation of user information such as healthcare information. Engine 130 may interface with various subprograms or databases, wherein the subprograms may be part of host network 112 and/or network 136. One skilled in the art will appreciate that engine 130 may additionally interface with components directly, through a LAN network or indirectly via any other system or network.

The databases and/or data sets comprising engine 130 may be interconnected such that information from one database and/or data set may be accessed by one, two, three or more other databases and/or data sets. By the term “access,” the databases may transmit, receive, obtain, link, view, connect, associate, interface, share, route, acquire, ascertain, retrieve, and/or gain information from one database to another. Thus, any information updated, received and/or sent to one database such as, for example, healthcare database 930, may be automatically updated throughout all or any portion of the other databases that are accessed by healthcare database 930. In addition, the databases comprising engine 130 may be configured with limited access rights/privacy rights. That is, a database owner may permit and/or prohibit other users, owners, issuers, and/or other third parties from accessing information stored on the database.

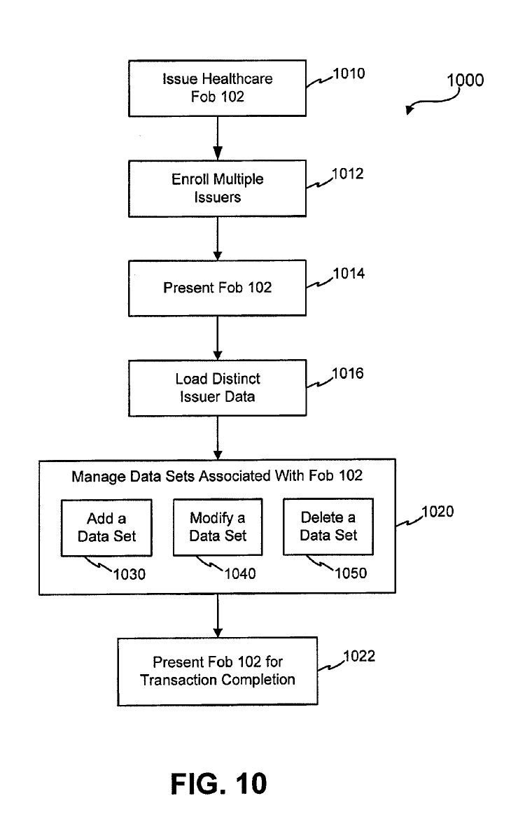

In general, systems and methods disclosed herein, are configured to facilitate the management of multiple distinct data sets associated with fob 102. Management of data sets may include such steps as adding, augmenting, updating and/or deleting data sets associated with fob 102. Such manipulations of the data may occur without replacing or reissuing fob 102. With reference to FIG. 10, an exemplary method 1000 according to the present invention is shown. Method 1000 may include issuing a healthcare fob 102 to a fob user (step 1010), enrolling multiple data set owners in a multiple account on fob 102 program (step 1012), and managing data sets associated with fob 102 (step 1020). In managing the data, method 1000 may determine, for example, whether the data should be added to a data set (step 1030), modified (step 1040) or deleted (step 1050), as described more fully below. Once the data is appropriately managed, fob 102 user may present the data contained on fob 102 to a healthcare system for completion of a transaction.

The system may be further configured such that, during an exemplary transaction, data sets associated with fob 102 may be managed. For example, the user may be prompted (e.g., on a screen, by electronic voice, by a store clerk, by a signal and/or the like) as to the possibility of adding, for example, a loyalty account to the same healthcare fob 102 and the user may also be presented with terms and/or conditions in a similar or different manner. The prompt may be configured to activate after the transaction terminal checks for a loyalty account, and discovers that none is present. The user may be prompted at any time during the transaction, and in one embodiment, the user is prompted at the completion of the transaction. If the user accepts the invitation to add data to fob 102, a new data set may be added (step 1030) and/or an existing data set is updated (step 1040). For example, if data is to be updated, the stand alone device may locate appropriate data to be updated on fob 102, and execute the updates (“modifications”) in accordance with data owner instructions, and the user, or clerk, may use the POS terminal for the transaction by selecting from a menu. If the data is to be added, the stand alone device may be configured to provide any account information (e.g., account identifier, security code, data owner routing number, etc.) to fob 102 for storage thereon. The stand alone may locate an appropriate (i.e., unused) database location on transaction instrument for storing the added data. The stand alone device facilitates storage of the data in a distinct location on fob 102 database, where the data is stored independently of any other data. In one embodiment of the invention, the data is added to a database location on fob 102 which may be reserved for independently storing all data owned by a particular data set owner (e.g., a BLOB), associated with a key for general data storage. Alternatively, the data may be stored in a distinct location on fob 102, which may be a separate location that is used to store any other data set. Further still, the data set may be stored in accordance with any storage format, and permitting the data to be stored and retrieved independently of other data.

The adding and updating of the data may be verified by the issuer, prior to executing the modifications. That is, the transaction location may be configured to send a message to the issuer, and then the issuer may apply its edit rules before sending a verification (or non-verification). If verified, all databases containing the data set to be updated or a mirror image of the data set to be updated, are modified in accordance with the user or issuer provided instructions, and/or the issuer defined data storage protocol or format.

In one exemplary embodiment, multiple account issuers may be enrolled in a multiple account management program using fob 102 in accordance with the invention (step 1012). That is, one or more issuers may supply the account number that they are using for the user, along with any other data (either ISO or BLOB). Permission for adding account issuer owned data may be obtained from the data set owner. The data set owner may then be requested to provide account information to be stored on a transaction instrument. The data set owner may then provide account information relative to a distinct user account for loading onto fob 102 in accordance with the present invention. The issuers may be enrolled prior to issuance of fob 102 or the issuers may be enrolled after issuance. By enrolling in the management program, the issuer may provide authorization for including the issuer-owned data on fob 102. The issuer-owned data may be included (e.g., added, deleted, modified, augmented, etc.) on fob 102 using a stand alone interaction device, POI 110, or user personal computer interface upon presentment of fob 102 to the POI 110 (step 1014). POI 110 may manipulate the issuer-owned data while preserving a format recognizable by an issuer account management system (step 1016). For example, POI 110 may identify the appropriate header or trailer associated with the data and add, delete or modify the data accordingly. POI 110 may manipulate the data using any manipulation instruction or protocol as provided by the data set owner so that the resulting manipulated data is still in a format recognizable by the data set owner system. POI 110 may be configured to manipulate the data based on the header. That is, POI 110 may be configured to recognize the format required by the data (e.g. the header describes the format of the data). In this way, POI 110 may manipulate the data while maintaining the data set owner's format. Alternatively, POI 110 may store the issuer-owned data on the fob 102 in any format, provided that the issuer-owned data is provided to the issuer system (or to healthcare system) in an issuer system (or healthcare system) recognizable format.

It should be noted that fob 102 may be issued with or without one or more data sets stored thereon. Fob 102 may be issued using various techniques and practices now known or hereinafter developed wherein an instrument is prepared (e.g., embossed and/or loaded with data) and made available to a user for effecting transactions. Although the present invention may contemplate managing data sets (step 1020) before issuing fob 102 (step 1010), in various exemplary embodiments, by way of illustration, the data sets are described herein as being managed (step 1020) after issuance (step 1010).

At any time after issuance (step 1010) of the healthcare fob 102, fob 102 may be used in a healthcare and/or commercial transaction. In one exemplary embodiment, a user communicates with a healthcare provider, indicates a desire to participate in a issuer/healthcare provided healthcare program. The user may communicate with the healthcare provider by, for example, presenting fob 102 to the healthcare provider and indicating a desire to complete a healthcare transaction. The healthcare data may be preloaded on fob 102. The user may indicate his desire to complete a transaction using any conventional process used by the healthcare provider. The user may further indicate that the user wishes to complete the transaction using fob 102. During completion of the transaction, the user may present fob 102 to a healthcare provider system (step 1022). Fob 102 is configured to communicate with the healthcare provider, using any conventional method for facilitating a transaction over a network.

In various exemplary embodiments, the steps of adding, deleting, augmenting and/or modifying data sets may be repeated. For example, first, second, and additional data sets may be added (step 1030) to fob 102 in any order. In one exemplary embodiment of the present invention, the first data set is owned by a first data set owner (i.e., first issuer) and the second data set is owned by a second data set owner (i.e., second issuer). Furthermore, the system may include replacing any portion of a first data set with any portion of a subsequent data set by deleting any portion of a data set (step 1050), then adding any portion of a data set (step 1030).

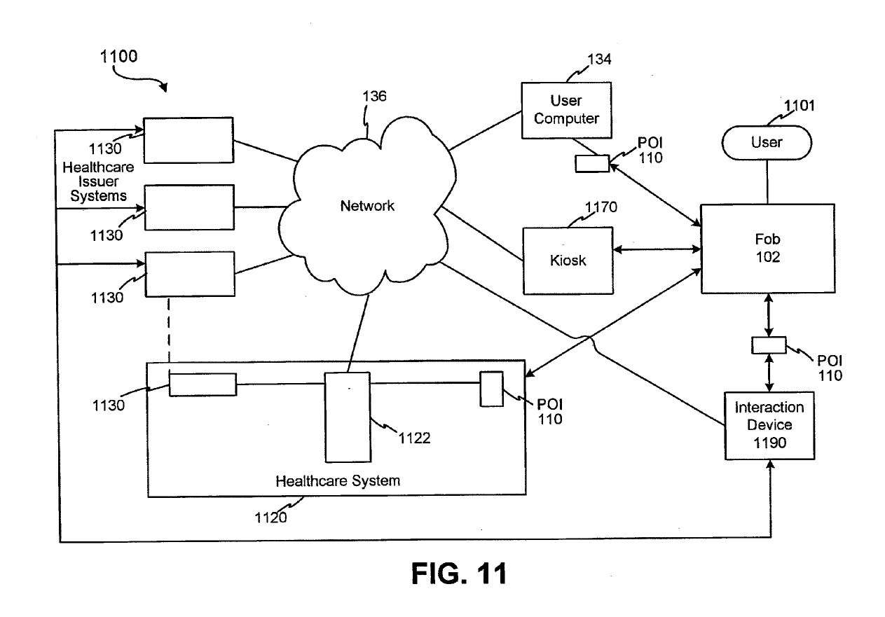

With reference now to FIG. 11, in one exemplary embodiment, a data set management system (“management system”) 1100 comprises a healthcare system 1120, various healthcare issuer systems 1130, and fob 102. Management system 1100 may further be accessed by a user 1101 on a self-service interaction device, such as, for example, user computer 134 or via a transaction device such as, for example, one or more POIs 110, kiosk 1170, stand-alone interaction device 1190, automated teller, or the like. Healthcare issuer systems 1130 are configured to interact with fob 102 to receive and/or exchange data facilitating a transaction. Healthcare system 1120 may be operated, controlled and/or facilitated by any hospital, healthcare provider, medical entity, or merchant that facilitates the transfer of data and/or payment to fob 102.

The self-service user interaction device may be any device suitable for interacting with fob 102, and receiving information from fob 102 user and providing the information to a healthcare provider, insurance carrier, merchant, account issuer, account manager, data set owner, hospital point-of-interaction and the like. For example, a user may use a self-service device configured with a PC to provide healthcare information to a physician via a website (e.g., WebMD®) to obtain medical care. In one example, the self-service user interaction device may be configured to communicate information to and from the transaction device and to manipulate the data sets stored thereon. The self-service interaction device may be in communication with the various components of the invention using any suitable communications protocol.

The self-service interaction device may be initialized prior to use. For example, the self-service interaction device may be any system which may be initialized (“configured”) to communicate with healthcare system 1120. Where the self-service interaction device is not initialized prior to attempting communications with the healthcare system 1120 or fob 102, the self-service interaction device may be initialized at the healthcare system 1120 location. The interaction device may be initialized using any conventional method for configuring device communication protocol.

User 1101 may communicate with the healthcare provider and/or healthcare system 1120 in person (e.g., at the hospital), or electronically (e.g., from a user computer 134 via network 136 and/or network 112). During the interaction, the healthcare provider and/or healthcare system 1120 may offer healthcare services and/or products to user 1101 and/or transmit and/or receive information from user 1101. The healthcare provider and/or healthcare system 1120 may also offer user 1101 the option of completing the transaction using fob 102. The healthcare provider and/or healthcare system 1120 may provide the options to user 1101 using interactive user interface, suitable website or other Internet-based graphical user interface that is accessible by users.

Healthcare issuer systems 1130 may be configured to manipulate a transaction account associated with the corresponding issuer-owned data stored on fob 102 (or database 214, discussed herein) in accordance with a related transaction. For example, healthcare issuer system 1130 may receive “transaction information” and manipulate an account status or balance in accordance with the information received. In accordance with the transaction amount, healthcare issuer system 1130 may, for example, diminish a value available for completing a transaction associated with the account, or healthcare issuer system 1130 may alter the information relative to the account user (e.g., medical insurance information, personal information, etc.).

It should be noted that healthcare issuer systems 1130 may also be configured to interact with fob 102, directly or indirectly via database 214, POI 110, and/or interaction device 1190 to individually manage data sets on fob 102. For example, healthcare issuer systems 1130 may manage data sets on database 214. In some embodiments, the data sets on database 214 may then be stored on fob 102 when fob 102 is presented. In other embodiments, healthcare issuer systems 1130 may store data set information within their own systems which may communicate with fob 102 via user computer 134, kiosk 1170, or healthcare system 1120. In such embodiments, healthcare issuer system 1130 may be configured to push the data set to the fob 102 via the POI 110, or healthcare system 1120, kiosk 1170, interaction device 1190 or computer 134 which may be configured to pull such information from healthcare issuer system 1130.

POI 110 and/or interaction device 1190 may provide instructions to the healthcare issuer systems 1130 for requesting receipt of issuer-owned data, such as for example, account data, user identification data, user demographic data, user insurance data or the like, which the issuer wishes to store on fob 102. POI 110 and/or interaction device 1190 may communicate with healthcare issuer systems 1130 using an issuer recognizable communications protocol, language, methods of communication and the like, for providing and receiving data. In one exemplary embodiment, issuer-owned data is received by POI 110 and/or interaction device 1190 from healthcare issuer systems 1130, and stored onto the fob 102. In one exemplary embodiment, the issuer-owned data is stored using healthcare issuer system 1130 format which may be later formatted in healthcare system 1120 recognizable protocol when provided to the healthcare system 1120. In one embodiment, the issuer-owned information is stored on fob 102 in the identical format with which it was provided by healthcare issuer system 1130.

In a typical example of healthcare issuer modification of the data sets, one or more data sets may be modified by healthcare issuer system 1130 directly via the healthcare issuer systems 1130, upon presentment of fob 102 to system 1130. That is, user 1101 may present fob 102 to healthcare issuer system 1130, and healthcare issuer system 1130 may modify the issuer data stored thereon, using any issuer defined protocol. Alternatively, the modifications, or instructions for modification, may be initiated at healthcare issuer system 1130, and provided to network 136. The modifications and/or modification instructions may additionally be provided to a suitable device configured to communicate with fob 102, receive information regarding the data stored on fob 102, and to write or overwrite the information contained on fob 102. For example, as noted, POI 110 and/or interaction device 1190 may be suitable interaction devices which may be used to provide information to fob 102 to modify the information stored thereon. POI 110 and/or interaction device 1190 may be any devices capable of receiving data management instructions from healthcare issuer systems 1130 and for updating the data stored on fob 102, in accordance with the instructions received. In this regard, POI 110 and/or interaction device 1190 may include any electronic components, databases, processors, servers and the like which may be used to modify the data stored on fob 102 using any suitable data modification protocol as is found in the art. Preferably, POI 110 and/or interaction device 1190 is configured to modify the data on fob 102 in accordance with a data owner defined protocol.

In one exemplary embodiment, POI 110 and/or interaction device 1190, may be configured to modify fob's 102 issuer-owned data when fob 102 is initially configured, prior to providing fob 102 to user 1101. POI 110 and/or interaction device 1190 may additionally be configured to modify the issuer data on fob 102 when fob 102 is next presented, for example, to POI 110. In this regard, POI 110 and/or interaction device 1190 may receive from multiple distinct healthcare issuer systems 1130, via the network 136, the issuer provided modifications/instructions and may update fob 102 in real-time or substantially real-time. The modifications may be provided to POI 110 and/or interaction device 1190 for storage and later use when fob 102 is next presented. Alternatively, POI 110 and/or interaction device 1190 may be configured to retrieve the instructions from healthcare issuer system 1130 when fob 102 is next presented to POI 110 and/or interaction device 1190. Further, where other devices, such as, for example, kiosk 1170, or the like, are likewise configured to modify the issuer data on fob 102, the invention contemplates that the real-time or substantially real-time modifications noted above may be made using those devices in similar manner as is described with POI 110 and/or interaction device 1190.

Alternatively, the device to which fob 102 may be presented, may not be equipped for updating or modifying the data stored on fob 102. For example, healthcare system 1120 may be any conventional healthcare provider system which communicates to healthcare issuer system 1130, and which permits user 1101 to complete a financial transaction, but which is not configured to modify the healthcare issuer data contained on fob 102. In general, conventional healthcare provider systems are not configured to write or overwrite data included on fobs 102 presented to the healthcare provider system for processing. That is, healthcare system 1120 may include little or no additional software to participate in an online transaction supported by network 136. Management of the data sets on fob 102 may be performed independent of the operation of healthcare system 1120 (e.g., via healthcare issuer system 1130 or interaction device 1190). As such, the present invention may require no retrofitting of healthcare system 1120, to accommodate system 1100 operation. Thus, where healthcare system 1120 is not configured to modify the data on fob 102, such modifications may be executed as described above with respect to modifications being executed at interaction device 1190, POI 110 and/or by the issuer at healthcare issuer 1130 system.

Healthcare system 1120, kiosk 1170, interaction device 1190, and/or POI 110 may include additional systems and methods for permitting fob 102 user 1101 to self-manage the data stored on fob 102. In this case, the systems 1120, 1170, 1190 and 110 may include an additional user interface for use by user 1101 to identify the modification action to be taken. Where the systems 1120, 1170, 1190 and/or 110 are configured to communicate with fob 102 and to modify the data thereon, the modifications may be completed or substantially completed in real-time or substantially real-time. For example, user 1101 may present fob 102 to one of systems 1120, 1170, 1190 and 110, provide instructions to systems 1120, 1170, 1190 and/or 110 for modifying the data on fob 102. The instructions may include, for example, “ADD,” “DELETE,” MODIFY,” and systems 1120, 1170, 1190 and/or 110 may modify the data stored on fob 102 in accordance therewith. These instructions will be described in greater detail herein. The modifications may be made on fob 102 in real-time or substantially real-time, for example, prior to permitting fob 102 to be used by user 1101. Alternatively, the modifications or instructions for modification may be provided by user 1101 to healthcare system 1120 or kiosk 1170, and healthcare system 1120 or kiosk 1170 may further provide the modifications/instructions to network 136 for use in later modifying the data. For example, the modifications/instructions may be provided by system 1120 and/or 1170 to healthcare issuer system 1130 managed by the issuer owning the data to be modified. Healthcare issuer system 1130 may provide the modifications to, for example, interaction device 1190, for updating fob 102 when next presented. The modifications/instructions may additionally be provided from network 136 to a remote database, where the issuer-owned data corresponding to fob 102 and the issuer may be additionally stored (i.e., on engine 130, described herein). In one exemplary embodiment, the modifications/instructions may be stored at healthcare issuer system 1130, until such time as fob 102 is next presented to a device configured to modify the data on fob 102. Once presented, the modifications/instructions may be provided to the device (e.g., computer 134, interaction device 1190, etc.) for modifying fob 102 data.

In another exemplary embodiment, user 1101 may self-manage the data sets by, for example, modifying the data sets using a conventional computer system 134, which may be in communication with network 136. Computer system 134 may or may not be configured to interact with fob 102. Where computer system 134 is not configured to interact with fob 102, user 1101 may provide modifications or instructions to healthcare issuer system 1130 for later use in modifying the corresponding fob 102 data, for example, when fob 102 is next presented in similar manner as described above. Where computer 134 is configured to interact with fob 102 to modify the data stored thereon, user 1101 may provide modifications/instructions to computer 134 for modifying the data on the financial instrument in real-time or substantially real-time. That is, computer 134 may be configured to interact with, read, add, delete, and/or modify the data sets on fob 102. Consequently, computer 134 may receive modifications/instructions from user 1101 and perform the modifications accordingly, and may modify the data in real-time or substantially real-time. User computer 134 may additionally be configured to receive authorization of the modifications/instructions from healthcare issuer system 1130 prior to executing user 1101 requested changes. In one exemplary arrangement, user 1101 may provide the modifications/instructions via network 136 which may be additionally provided to healthcare issuer system 1130. Healthcare issuer system 1130 may receive user 1101 modifications/instructions and verify whether the identified updates are available to user 1101 or if the identified updates are valid. If the identified updates are authorized, healthcare issuer system 1130 may update a data storage area associated with fob 102. For example, healthcare issuer system 1130 may update an issuer database (not shown) containing data corresponding to the issuer-owned data associated with fob 102. Alternatively, healthcare issuer system 1130 may provide modifications/instructions to a database positioned remotely to healthcare issuer system 1130 for use in modifying the data stored thereon, which is associated to fob 102. As such, in accordance with the present invention, user 1101 may self-manage the data via, for example, user computer 134, kiosk 1170, healthcare system 1120, and/or a POI 110.

In one exemplary method of self-management, user 1101 logs onto a website via user computer 134, or onto a stand alone device, such as, for example, interaction device 1190 or kiosk 1170, and selects options for configuring data sets on fob 102. The changes may be transmitted to fob 102 RFID reader 104 configured to communicate the data to fob 102. In this context, RFID reader 104 may be any conventional transponder device reader or writer.

As noted, modifications to the data stored on fob 102 may be made in real-time, substantially real-time or batch process when fob 102 is presented to interaction device 1190, POI 110 and/or to RFID reader 104. However, as noted, various embodiments of the invention include a remote database 930 on engine 130 in communication with healthcare issuer system 1130 via network 136. The remote database 930 may additionally be in communication with one of user computer 134, kiosk 1170, healthcare system 1120 and/or interaction device 1190, for variously receiving modifications or instructions for performing modifications to the data stored thereon. In addition, database 930 may contain a data storage area which “mirrors” the data stored on fob 102. In this context “mirrored” or “mirror” may mean that the data is stored on database 930 in substantially identical configuration and format as stored on fob 102. As such, the present invention may be configured to permit modifications made to fob 102 data to be mimicked on corresponding data locations on database 930. For example, user 1101 may self-manage the data on database 930 via a user interface in communication with database 930 via network 136. In one exemplary embodiment, user 1101 may communicate with a “website” which is used to manage database 930, wherein database 930 is a database including unique locations for storing the issuer provided data and data sets correlative to the data and data sets stored on fob 102. The website may include an account management application which permits user 1101 to select which user accounts to add, delete, or modify with respect to fob 102. That is, user 1101 may provide unique identifying information to user computer 134 which may be recognized by the system (e.g., healthcare issuer system 1130 and/or remote system managing database 930) thereby permitting user 1101 to access the data corresponding to the unique identifying information stored on database 930. Further, prior to permitting modifications to database 930, the issuer owning the data may require authorization that such modifications may be performed. Further still, the present invention contemplates that database 930 may be self-managed by user 1101 in a similar manner, where healthcare system 1120, kiosk 1170 and/or interaction device 1190 are configured to provide modifications/instructions to the healthcare issuer systems 1130 and database 930.

As noted, in some exemplary embodiments of the invention, authorization must be obtained from healthcare issuer systems 1130 prior to executing any modifications to the data contained on fob 102 and/or database 930. Authorization may be obtained by requesting the authorization during the modification process. Authorization may be given where user 1101 provides the more appropriate security information, which is verified by healthcare issuer system 1130. The security information may be, for example, a security code granting access to the issuer-owned data on fob 102 or database 930. For example, POI 110 and/or RFID reader 104 may be configured to allow the input of a code, or an answer to a prompt which is provided to and verified by healthcare issuer system 1130. Once verified the modification requested may be made to the data contained on fob 102.

It should be noted that the authorization code may be used to permit user 1101 to select which issuer provided data to utilize for completion of a transaction. For example, POI 110 and/or RFID reader 104 may be programmed to search fob 102 for a data set containing a particular insurance data set, or to locate all available data sets for providing to user 1101 display available data sets to user 1101, thereby permitting user 1101 to select which data set to use to complete a healthcare transaction. If no data set is found, POI 110 and/or RFID reader 104 may alert user 1101 or prompt the healthcare provider to alert user 1101 of the possibility of adding issuer-owned data to fob 102. A positive response to this alert may cause POI 110 and/or RFID reader 104 to add an issuer data set to fob 102.

It is noted that user 1101 may already be a carrier of a certain type of insurance and/or healthcare program managed by a healthcare issuer system 1130 in which case the associated user 1101 insurance data may be assigned to user 1101 for inclusion on fob 102. As such, user 1101 may be permitted to add the insurance data set to fob 102. Alternatively, the user may become an insurance holder by selecting to add the insurance information to fob 102, using, for example, interactive device 1190. In some embodiments, changes made to the data sets stored on fob 102 may be updated to fob 102 in real-time or substantially real-time, where device 1190 is in communication with fob 102. Or the changes may be made the next time user 1101 presents fob 102 to POI 110, RFID reader 104 or to kiosk 1170, healthcare system 1120, or the like.

In another exemplary embodiment of the present invention, healthcare system 1120, kiosk 1170, and/or user computer 134 may be configured to interact with fob 102 via RFID reader 104.

In exemplary embodiment, management of data sets is facilitated by annotating the data set with a status indicator (e.g., condition header); (e.g., LOADED, INITIALIZED, READY, BLOCKED, REMOVABLE or DELETED).

In this regard, a data set may have a LOADED status when the information related to that data set has been stored in association with fob 102, but remains dormant. For example, an insurance account may have been added to fob 102 that has not yet been activated. In some instances, the loaded data set needs to be further configured before it is ready to be used. For example, the data set may be modified to include a particular hospital in a chain of hospitals, the identification of user's 1101 primary care physician, or to reflect user's 1101 medical allergies. In another example, a particular healthcare program may be added in association with fob 102, and the data set marked LOADED. In another example, user 1101 may interact with kiosk 1170 or the like to input personal information and configure the healthcare program data set. Once such a data set has been configured, it may be annotated with an INITIALIZED status.

The status of a data set may be set as READY when the data set is ready to be utilized. For example, user 1101 may enter a secret code to indicate that user 1101 is ready to use the data set. In one example, the data set may be marked as READY when that data set is first accessed to receive a healthcare service. It will be noted that in accordance with other embodiments of the present invention, the status of a data set may be set at READY the moment it is loaded to fob 102. Furthermore, it is possible to change the status between READY, LOADED, and INITIALIZED, under appropriate circumstances. Thus, the data sets may be managed through any one or more of these states and in various orders.

It may also be desirable to prevent use of a data set and/or the associated functionality for a period of time. Thus, the status indicator may be set to BLOCKED. The setting of the status indicator to BLOCKED may, for example, disable the use of the data set. In one exemplary embodiment, an appropriately configured RFID reader 104 may be configured to recognize the BLOCKED status indicator when accessing the data set and to prevent use of that data set example.

In addition, for various reasons, user 1101 may desire to remove a data set from fob 102. User 1101 may, for example, desire to use the available space on fob 102 for other data sets, or may remove the data set for security reasons. Furthermore, circumstances may arise where the owner of the data set desires to remove the data set from one or more fobs 102, such as when a insurance program expires. In these instances, the data set may be marked as REMOVABLE. Under these circumstances, the memory associated with the data set is available to receive information associated with future added data sets, but for the moment retains the old data set. A REMOVABLE data set may again be made READY under various configurations.

The REMOVABLE data set may subsequently be removed from fob 102 and marked DELETED. A DELETED status indicator may be used to indicate that a portion of fob 102 is available to store one or more data sets. It is noted that data sets may be directly deleted without going through the step of making the data set REMOVABLE. In one example, a data set may be removed from fob 102 if the security of the account associated with the data set is compromised (e.g., stolen password). Furthermore, as appropriate, the status of data sets may be changed to different states. Under appropriate circumstances one or more of any of the six status indicators LOADED, INITIALIZED, READY, BLOCKED, REMOVABLE, or DELETED or other suitable status indicators may be used to annotate a BLOB or other similar data set.

Although the data sets described herein may be managed without status indicators, nevertheless, such status indicators facilitate management of data. For example, regardless of a first data set owner's ability to interpret the information stored in a data set owned by another party, the first owner may interpret the status indicator to determine whether the data set is LOADED, DELETED, or the like. The determination that a data set is DELETED facilitates the addition of new data sets by independent owners without overwriting other data sets on fob 102. In addition, the use of tags or status indicators may facilitate the use of global rules, which may simplify operations and/or commands. Status indicators may also enhance interoperability between data sets. Nevertheless, a data set owner may chose not to use a status indicator even if the opportunity is available.

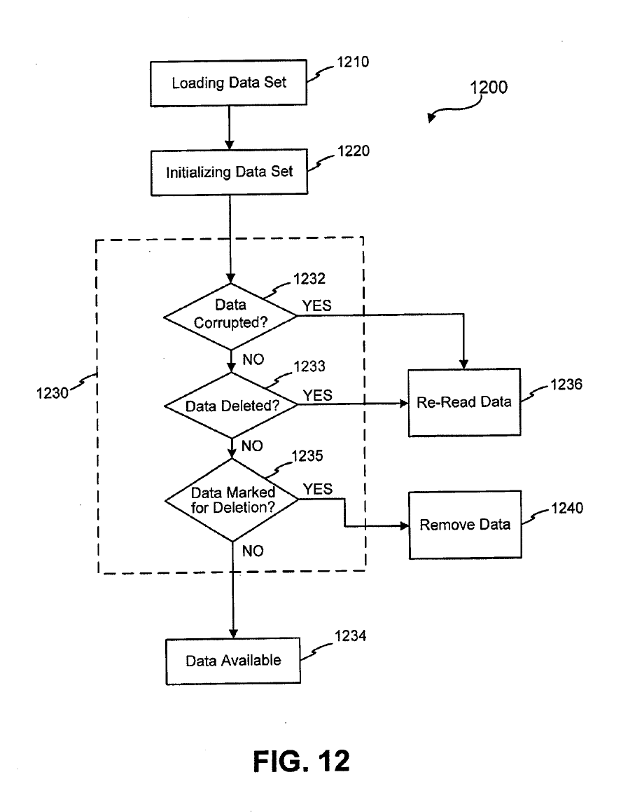

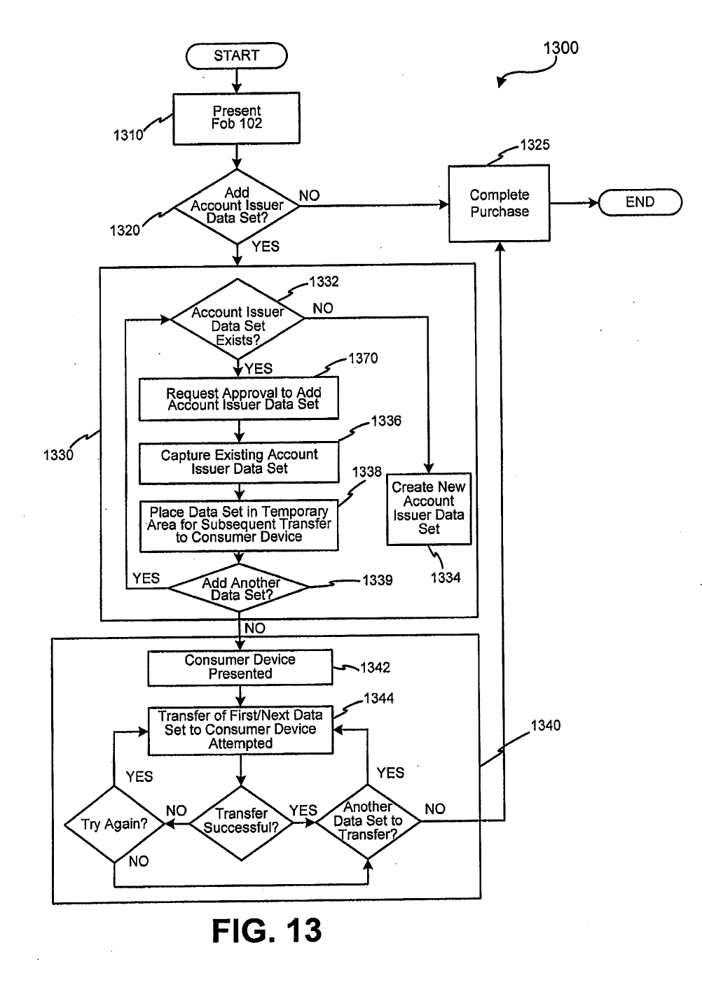

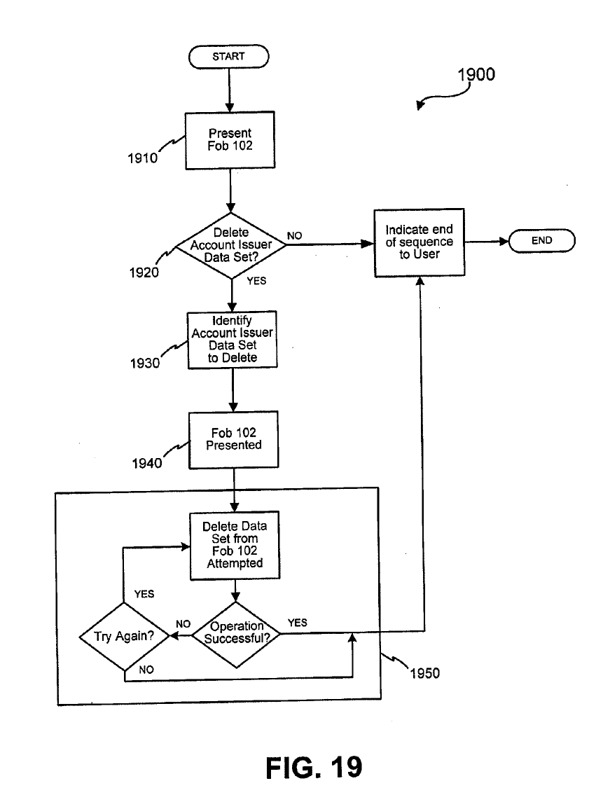

FIG. 12 illustrates a general overview of an exemplary data set management method 1200 comprising the steps of: loading a data set (step 1210), initializing a data set (step 1220), verifying availability of data set (step 1230), and deleting a data set (step 1240). In this manner, a data set may be added to fob 102 and utilized until it is deleted. The adding and deleting steps are described in further detail with reference to FIGS. 13 and 19. Furthermore, the ability to update, modify, replace and/or delete a data set may be subject to security requirements.

In one embodiment, the various processes may include user 1101 facilitating the input of information into a data management system to cause the data set to be loaded. The information may be inputted by fob 102, keypad, magnetic stripe, smart card, electronic pointer, touchpad and/or the like, into a user computer 134, POI terminal 110, kiosk 1170, ATM terminal and/or directly into healthcare system 1120 via a similar terminal or computer associated with healthcare provider server 1122. The information may be transmitted via any network 136 discussed herein to healthcare system 1120 or healthcare issuer systems 1130. In another embodiment, the healthcare provider may enter the information into healthcare issuer system 1130 on behalf to user 1101. This may occur, for example, when user 1101 and/or healthcare issuer system 1130 authorizes the management of data sets on fob 102 over a telephone and the service representative inputs the information. In this embodiment, fob 102 may be updated at the next presentment opportunity such as when user 1101 attempts to compete a transaction using fob 102.

Any suitable procedures may be utilized to determine whether a data set is currently ready for use and available (step 1230). In one example, when fob 102 is presented, the availability of the data set is verified by checking whether the data set has been corrupted or blocked (step 1232), or deleted (step 1233). For example, the data set may be checked to determine if the data set has been accessed or altered without permission (“corrupted”) or if the data set exists or has been removed from fob 102 (“deleted”). The check may be performed using any suitable protocol or comparing data. If the answer to these questions is no, then the data set is available and ready for use (step 1234). If the data is corrupted or blocked, subroutines may be used to attempt to retry reading the data (step 1236). If the data set is marked deleted or removable, subroutines will prevent access to the data set (step 1235) and remove the data set (step 1240). For example, a suitable subroutine may place a DELETE “marker” on the data set which prevents the data from being transmitted during completion of a healthcare transaction. The data set may then be marked for deletion and deleted from fob 102 at the next presentment of the device. In similar manner, where the data set is corrupted, a CORRUPTED marker may be appended to the data set and the data set is prevented from being transmitted during completion of a healthcare transaction. The marker may be a header or trailer as discussed herein.

Various methods may be used to add a data set to fob 102 or to replace a data set on fob 102. FIG. 13 illustrates an exemplary method of adding a data set to fob 102, including the general steps of presenting fob 102 (step 1310), verifying the addition of the data set to fob 102 (step 1320), placing the data set in a temporary holding area (step 1330), and adding the data set (step 1340).

More particularly, user 1101 presents fob 102 (step 1310) to RFID reader 104 configured to communicate with fob 102. User 1101 may present fob 102 at a point-of-purchase or to an interaction device 1190 and/or kiosk 1170. For example, user 1101 may wave fob 102 in front of POI 110 in a hospital, which is configured to receive data from fob 102. Alternatively, user 1101 may present fob 102 at a self-service location such as a kiosk 1170 in a mall. Moreover, user 1101 may present fob 102 to a peripheral device associated with a personal computer, or the like.

User 1101 is then given the opportunity to add a data set to fob 102. For example, RFID reader 104 may detect the absence of a particular data set on fob 102 by searching fob 102 data base and comparing the existing data sets to the data set to be added. If the data set to be added is not found on the data base, user 1101 may be prompted to confirm the addition of this data set to fob 102 (step 1320). The user may be prompted via an interactive user interface displaying the option to add the data set. In one example, when user 1101 presents fob 102 to a healthcare provider, RFID reader 104 may detect the absence of an insurance data set and provide a message on a display to user 1101 or the hospital clerk indicating that the insurance data set can be added if desired. User 1101 may answer in the negative and complete the healthcare transaction using typical transaction methods (step 1125). Alternatively, if user 1101 provides an affirmative response, the algorithm may prepare a data set for communication with fob 102 (step 1130). The process may determine whether the data set (or information that could be used to create the data set) exists in some form or on some device other than on fob 102 (step 1132). Determining whether a data set exists may involve querying a healthcare issuer system 1130, database 930, or the like. For example, healthcare issuer system 1130 may compare the data set to other data sets healthcare issuer system 1130 has assigned to a particular user 1101. If the data set is not assigned to a particular user, then issuer system may determine that the data set is available for adding to fob 102. Determining whether a data set exists may also take place when a store clerk verbally asks (or a screen prompts) user 1101 to present an insurance card containing the information. For example, the data set may exist on a an insurance card, it may be stored in magnetic stripe form, bar code, and/or the like.

If the data set exists in an accessible form, the data set may be captured (step 1336). In this example, user 1101 may present the insurance card and the data read from the insurance card may then be stored in a data set associated with fob 102. For example, user 1101 may desire to add a dental insurance card to the user's 1101 fob 102. User 1101 may swipe, scan or otherwise present the dental insurance card such that the data set from the dental insurance card is captured. The system may be further configured such that the healthcare provider, kiosk 1170, or computer system may access healthcare issuer system 1130 to obtain information for creating the data set. Thus, if user 1101 does not have the insurance card on user's 1101 person, system 1130 may prompt the clerk to request identifying/security information and to access the user's 201 account and therefore facilitate adding an insurance data set associated with user's 1101 fob 102. Any other suitable methods of capturing data sets may also be used.

If the data set does not exist, a new data set may be created (step 1334) for inclusion on fob 102. Creation of the data set may, for example, involve filling out an application, providing name and address, creating an account, and/or the like. In either event, the pre-existing or newly created data set is temporarily held in a storage area (e.g., database 930, local memory or the like) for transfer to fob 102 (step 1338). Additional data sets may be prepared for transmittal to fob 102 (step 1339).

In this exemplary embodiment, fob 102 is presented again to RFID reader 104 (step 1342). RFID reader 104 is configured to attempt to transfer the data set(s) to fob 102 (step 1344). For example, existing RFID reader 104 may be configured with software and/or hardware upgrades to transmit data to fob 102. In one exemplary embodiment, if the data sets were not transferred correctly, the process may try the transfer again. In another exemplary embodiment, data sets are added one at a time or altogether. Thus, user 1101 may wave fob 102 past RFID reader 104 one or more times during the addition process. The transaction may be completed (step 1325) using the new data set or another selected method of payment. The same steps may be used in a self-service embodiment, however, in one embodiment, no healthcare transaction takes place along with the addition of data sets. It should also be noted that under appropriate circumstances, user 1101 could add data sets at a point-of-interaction without actually completing a transaction.

In various exemplary embodiments, user 1101 and/or the owner of the data set may manage the data set (i.e., steps 1332-1339) in advance of presenting fob 102. For example, user 1101 on user computer 134 may choose to add or delete data sets via a website configured for management of data sets. In another example, healthcare issuer system 1130 may add functionality to an account and may desire to update the data set associated with that account. In either example, data sets that have been prepared in advance, may be ready for transmission upon presentment of fob 102. The transmission of the data sets may be transparent to user 1101. For example, user 1101 may present fob 102 (step 1342) to complete a healthcare transaction and the waiting data sets may automatically be added to the user's 1101 fob 102 (step 1340).

Similar steps may be taken to replace or update data sets with new information. For example, user 1101 at a point-of-interaction may be informed of an upgrade in functionality associated with an account or other data set. Following similar steps as discussed with reference to FIG. 13, the existing data set on fob 102 is replaced with a new data set. Moreover, depending on permission rights and/or hierarchies in place, if any, an existing data set may be replaced with an unrelated data set. Other methods of adding and replacing data sets may also be used to manage data sets on fob 102.

Furthermore, data sets may be deleted using any suitable techniques. For example, FIG. 19 illustrates an exemplary data set deletion method 1900. User 1101 presents fob 102 at a point-of-interaction 110, self-service location, or the like (step 1910). POI 110 may be configured to facilitate user 1101 providing input regarding deletion of a data set (step 1920). For example, POI 110 may ask user 1101, via a test screen, whether user 1101 desires to manage the data sets on fob 102. Through a series of menus and/or questions, user 1101 may identify data sets that user 1101 desires to delete.

Furthermore, POI 110 may be configured to interrogate database 214 or specific healthcare issuer systems 1130 to determine whether the deletion of a data set has been requested earlier. If user 1101 requests deletion of one or more data sets, the data sets are then identified (step 1930). It will be noted that step 1930 may occur concurrently with step 1920 or user 1101 may request deletion of a specific account at this step. In other embodiments, accounts may be deleted per predefined rules or policies, and/or the like. Upon presenting fob 102 again, the identified data set(s) are removed from fob 102 (steps 1940 and 1950). Other methods of deleting data sets may also be used to manage data sets on fob 102.

In an exemplary embodiment, management of the data sets may further include selecting preferences for use of the data sets. For example, user 1101 may indicate a desire to use data set A, associated with a primary insurance carrier, as a first option, but to use data set B, associated with a secondary insurance carrier when data set A is not available. In another example, one data set may be used for hospital transactions while another data set may be used for private physician transactions. User's 1101 data set preferences may be stored on fob 102 as a data set. In this example, when fob 102 is presented, all available data sets are read and RFID reader 104 determines which data sets are to be used based in part on the preferences stored on fob 102, which preferences may be updated from time to time.

In another embodiment, fob 102 may be configured to comprise two or more antennae that are both configured to send and receive information and fob 102 may be responsive to different RF frequencies. In this exemplary embodiment, each antenna may be configured to communicate using a particular protocol and/or frequency. Thus, fob 102 may be configured to communicate with two or more RFID readers 104 that each communicate with fob 102 using different transmission frequencies. For more information on dual antenna fobs, see U.S. patent application Ser. No. 10/192,488, filed Jul. 9, 2002, by inventors Michael J. Berardi, et al., and entitled “SYSTEM AND METHOD FOR PAYMENT USING RADIO FREQUENCY IDENTIFICATION IN CONTACT AND CONTACTLESS TRANSACTIONS” and its progeny, which are hereby incorporated by reference.

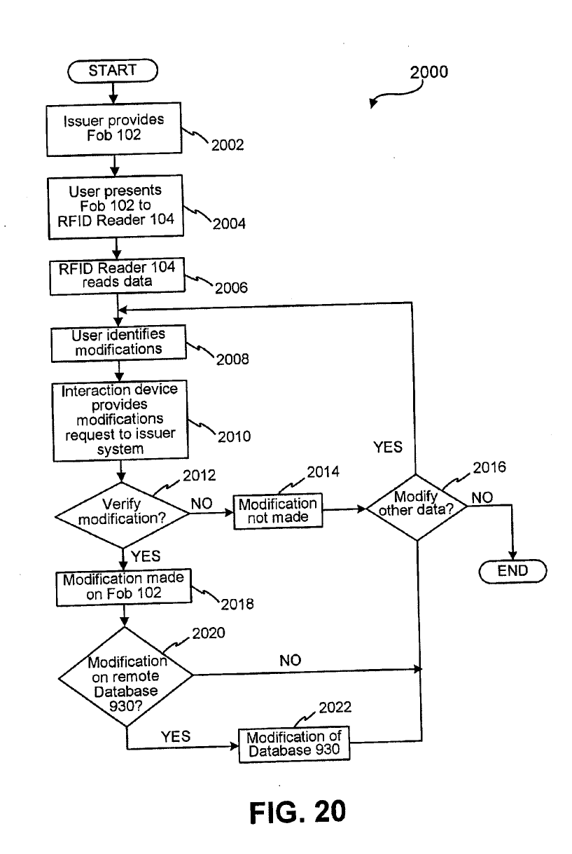

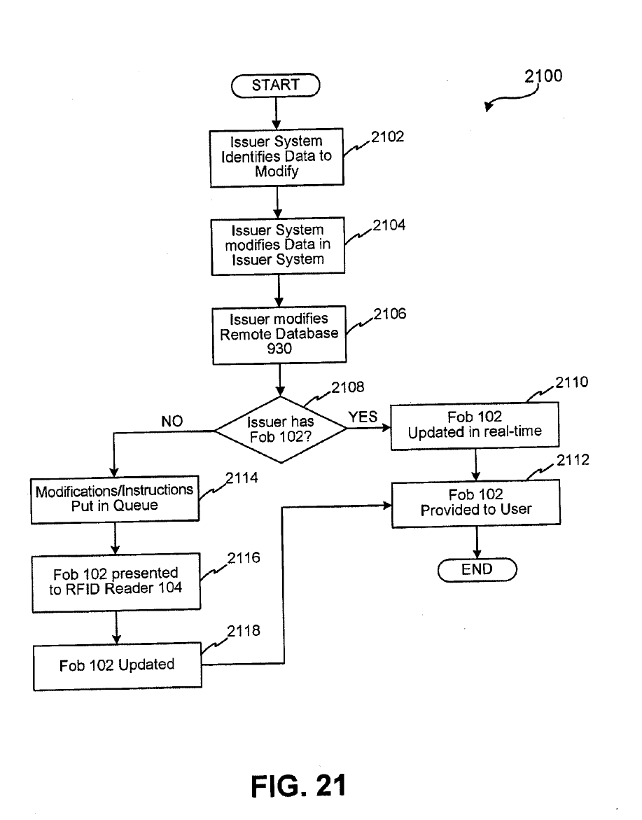

As noted, the data associated with fob 102 may be modified by user 1101 and/or by healthcare issuer system 1130. FIGS. 20 and 21 respectively, depict exemplary methods for user 1101 and healthcare issuer system 1130 data management. For example, with respect to user 1101 self-management, healthcare issuer system 1130 may provide user 1101 with fob 102 (step 2002). Fob 102 may be provided with pre-stored issuer-owned data, or fob 102 may be configured to permit user 1101 to add the data at a later date. User 1101 may the present fob 102 to RFID reader 104 for initiating the self-management process (step 2004). RFID reader 104 may then read the data on fob 102, and provide the data to interaction device 1190 and/or POI 110 for displaying to user 1101 (step 2006). Alternatively, interaction device 1190 and/or POI 110 may provide user 1101 a list of available data to be added to fob 102.

User 1101 may then be permitted to identify which data user 1101 wishes to modify (step 2008). Identification of the data may include providing the data with a trailer or header indicating the action to be taken (e.g., add, delete, augment, overwrite, etc.). The header and an indicator of the data to be modified may then be provided to healthcare issuer system 1130 (step 2010) for verification as to whether such desired modifications are available to user 1101 (step 2012). If the desired modifications are not available, the modifications will not be made and user 1101 is notified accordingly (step 2014). User 1101 may then be permitted to identify whether other data is to be modified (step 2016). If so (step 2008), interaction device 1190 and/or POI 110 may provide a request for modification to healthcare issuer system 1130 (step 2010) and the verification process is repeated.

Alternatively, where healthcare issuer system 1130 verifies that the modifications may be made (step 2012), interaction device 1190 and/or POI 110 may make the modifications to the appropriate data on fob 102 (step 2018). Additionally, where the system 1100 includes a remote database 930 for storing a mirror image of the data contained on fob 102 (step 2020), interaction device 1190, POI 110 and/or healthcare issuer system 1130, may facilitate modification of remote database 930 (step 2022). User 1101 may then be permitted to select other data sets to modify (step 2016), in similar manner as was described above.

In either case, where the modifications are complete, user 1101 may then present fob 102 to a healthcare provider for use in completing a transaction.

FIG. 21 depicts an exemplary method 2100 wherein healthcare issuer system 1130 manages the data contained on fob 102. For example, the issuer may identify on healthcare issuer system 1130 which data sets are to be modified (step 2102). The modifications may then be made to the corresponding data set stored on healthcare issuer system 1130 (step 2104). Where system 1100 includes remote database 930, healthcare issuer system 1130 may provide the modifications/instructions to database 214 for updating database 930 accordingly (step 2106).

In addition, healthcare issuer system 1130 may query as to whether healthcare issuer system 1130 is in possession of fob 102 for executing the modifications to the data set on fob 102 in real-time or substantially real-time (step 2108). If so, the modifications are made accordingly (step 2110) and fob 102 may then be provided to user 1101 for use in completing a healthcare transaction using the distinct data sets modified (step 2112).

Where healthcare issuer system 1130 is not in possession of fob 102 at the time the healthcare issuer determines that modifications to the data on fob 102 are to be made (step 2108), the modifications may be made on healthcare issuer system 1130 (step 2104), and may be placed in queue, for uploading to fob 102 when it is next presented to healthcare issuer system 1130 or to the appropriate RFID reader 104 (step 2114). When fob 102 is presented thusly (step 2116), healthcare issuer system 1130 may be notified that fob 102 is available for modifying, and healthcare issuer system 1130 may then provide the instructions for modification (e.g., modified data including headers) to the appropriate RFID reader 104 for modifying fob 102 (step 2118). Fob 102 may then be provided to user 1101 for use in completing a transaction (step 2112).

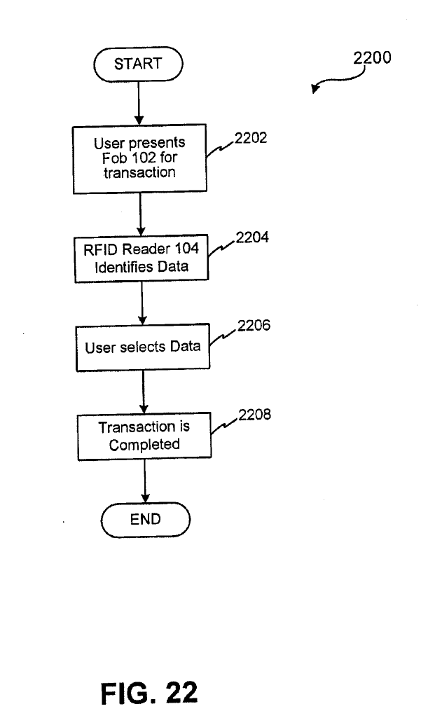

As noted, fob 102 may include multiple data sets which correspond to distinct healthcare issuer systems 1130, and which may be used to complete a healthcare transaction. User 1101 may be permitted to choose which data set to use for healthcare transaction completion. FIG. 22 illustrates an exemplary method 2200 by which user 1101 may choose which of the data sets to use to complete a healthcare transaction. For example, user 1101 may present fob 102 to healthcare system 1120 for use in completing a healthcare transaction (step 2202). Healthcare system 1120 may then read the data stored on fob 102 and report to user 1101 all distinct data sets which may be used to complete a healthcare transaction (2204). User 1101 may then select the appropriate data set (step 2206) and the healthcare transaction is completed accordingly (step 2208).

It should be noted that completion of a healthcare transaction may be performed under any business as usual standard employed by the healthcare provider and/or healthcare issuer system 1130. For example, the healthcare provider server 1122 may be configured to communicate transaction data to the appropriate healthcare issuer system 1130, in real-time or substantially real-time, or by using batch processing at the end of each day. Any suitable means for delivering the transaction data to the healthcare issuer systems 1130 may be used. In one exemplary embodiment of the present invention, the transaction data may be delivered to healthcare issuer system 1130 via network 136. Healthcare issuer system 1130 may receive the transaction information and process the transaction under issuer defined protocol independent of any other protocol used by other issuers to process a transaction. Healthcare issuer system 1130 may receive the transaction data and provide the healthcare provider with the appropriate satisfaction for the transaction.

In another exemplary embodiment of the present invention, system 100A may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof. Certain of these technologies will be described in greater detail herein. Moreover, while some of the examples discussed herein may include a particular biometric system or sample, the invention contemplates any of the biometrics discussed herein in any of the embodiments.

The biometric system may be configured as a security system and may include a registration procedure in which a user of transaction instrument (e.g., fob 102) proffers a sample of his fingerprints, DNA, retinal scan, voice, and/or other biometric sample to an authorized sample receiver (ASR). An ASR may include a local database, a remote database, a portable storage device, a host system, an issuer system, a healthcare provider system, a fob issuer system, a healthcare system, an employer, a financial institution, a non-financial institution, a loyalty point provider, a company, the military, the government, a school, a travel entity, a transportation authority, a security company, and/or any other system or entity that is authorized to receive and store biometric samples and associate the samples with specific biometric databases and/or transaction instruments (e.g., fobs 102). As used herein, a user of a fob, fob user, or any similar phrase may include the person or device holding or in possession of the fob, or it may include any person or device that accompanies or authorizes the fob owner to use the fob.

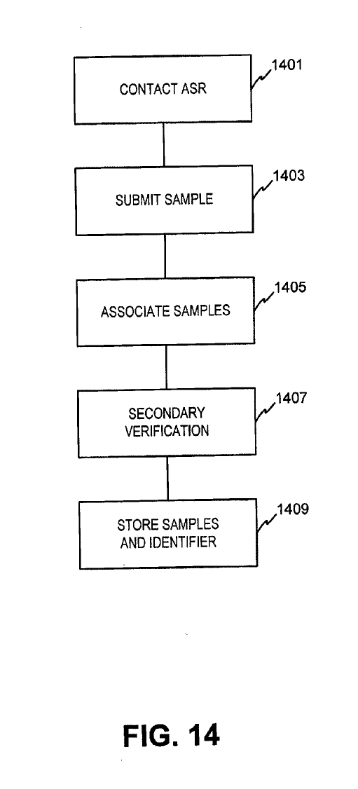

FIG. 14 illustrates an exemplary registration procedure in accordance with the present invention. In one embodiment, a fob user may contact an ASR to submit one or more biometric samples to an ASR (step 1401). The fob user may contact the ASR and submit a sample in person, through a computer and/or Internet, through software and/or hardware, through a third-party biometric authorization entity, through a kiosk and/or biometric registration terminal, and/or by any other direct or indirect means, communication device or interface for a person to contact an ASR.

A fob user may then proffer a biometric sample to the ASR (step 1403). As used herein, a biometric sample may be any one or more of the biometric samples or technologies, or portion thereof, described herein or known in the art. By proffering one or more biometric samples, a biometric may be scanned by at least one of a retinal scan, iris scan, fingerprint scan, hand print scan, hand geometry scan, voice print scan, vascular scan, facial and/or ear scan, signature scan, keystroke scan, olfactory scan, auditory emissions scan, DNA scan, and/or any other type of scan to obtain a biometric sample. Upon scanning the sample, the system may submit the scanned sample to the ASR in portions during the scan, upon completing the scan or in batch mode after a certain time period. The scanned sample may include a hardcopy (e.g., photograph), digital representation, an analog version or any other configuration for transmitting the sample. The ASR receives the sample and the ASR may also receive copies of a fob user's biometric data along with the sample or at a different time (or within a different data packet) from receiving the sample.

The ASR and/or fob user 102 may store the sample in digital and/or any storage medium known in the art and correlate and/or register the sample with fob user information. By storing the sample in digital format, the ASR may digitize any information contained in one of the biometric scans described herein. By storing the sample in any storage medium, the ASR may print and/or store any biometric sample. Hardcopy storage may be desirable for back-up and archival purposes. As used herein, registered samples may include samples that have been proffered, stored and associated with user information.

The biometric sample may also be associated with user information (step 1405). The sample may be associated with user information at any step in the process such as, for example, prior to submission, during submission and/or after submission. In one embodiment, the user may input a PIN number or zip code into the POI terminal, then scan the biometric to create the biometric sample. The local POI system may associate the biometric sample data with the PIN and zip code, then transmit the entire packet of information to the ASR. In another embodiment, the POI may facilitate transmitting the sample to an ASR, and during the transmission, the sample may be transmitted through a third system which adds personal information to the sample.

The information associated with the biometric sample may include any information such as, for example, fob user information, fob 102 information, fob 102 identifier information, fob 102 vender information, fob 102 operability information, and/or fob 102 manufacturing information. Fob 102 information is not limited to transponder information and may include information related to any healthcare information and/or any transaction instrument such as smart cards, credit cards, debit cards, healthcare provider-specific cards, loyalty point cards, cash accounts and any other transaction instruments and/or accounts. The fob user information may also contain information about the user including personal information—such as name, address, and contact details; financial information—such as one or more financial accounts associated with the fob user; loyalty point information—such as one or more loyalty point accounts (e.g., airline miles, charge card loyalty points, frequent diner points) associated with the fob user; and/or non-financial information—such as employee information, employer information, medical information, family information, and/or other information that may be used in accordance with a fob user.

For example, fob user may have previously associated a medical insurance account and a dental insurance account with his biometric sample which is stored at an ASR. Later, when fob user desires to access healthcare information stored on the fob, fob user may submit his biometric sample while using fob 102 for accessing information at the POI. The POI may facilitate sending the biometric sample to the ASR such that the ASR authorizes the biometric sample and checks a look-up table in the ASR database to determine if any information is associated with the sample. If information (e.g., insurance accounts) is associated with the sample, the ASR may transmit the information to the POI terminal. The POI terminal may then present fob user with a list of the two accounts associated with the biometric sample. Fob user and/or a healthcare administrator may then chose one of the accounts in order to continue and finalize the information transaction.

In another embodiment, fob user may associate each account and/or type of information with a different biometric sample. For example, during registration, fob user may submit a sample of his right index fingerprint, and request that the system primarily associate this sample with a particular credit card and/or account. Fob user may additionally submit a sample of his left index fingerprint and request that the system primarily associate the sample with a particular medical insurance account. Additionally, fob user may submit his right thumbprint and request that the system primarily associate that sample with a particular dental insurance account. By “primarily” associating a sample with an account, the system initially associates the sample with that account. For example, fob user submitting his right index fingerprint for a financial transaction may have money for a healthcare transaction taken from his credit card account. Fob user may additionally specify which accounts should be secondarily associated with a sample. For example, fob user may have a medical insurance account secondarily associated with his right index fingerprint. As a result, if fob user submits his right index fingerprint for a transaction, and the primary account associated with the sample may be used to pay the account, while the secondary account may be accessed in order to provide further information for the transaction.

While primary and secondary account association is described herein, any number of accounts may be associated with a sample. Moreover, any hierarchy or rules may be implemented with respect to the association. For example, the fob user may instruct the system to access a medical insurance account when it receives a right index fingerprint sample, the transaction involves the use of a debit card and the transaction involves paying a co-pay amount. While fingerprint samples are discussed herein, any biometric sample may have one or more accounts associated with it and may be used to facilitate a transaction using any of the routines discussed herein.

The ASR and/or fob user may associate a specific fob 102 identifier with the biometric sample by any method known in the art for associating an identifier (e.g., through the use of software, hardware and/or manual entry.) The ASR may additionally verify the fob user and/or fob 102 by using one or more forms of the user's secondary identification (step 1407). For example, the ASR may verify the fob user by matching the fob information to information retrieved from scanning information from a fob user's driver's license, medical insurance card, and/or other form of secondary identification. The ASR may verify fob 102 by contacting the vendor of fob 102 to confirm that fob 102 was issued to a specific fob user. In another embodiment, the ASR may activate fob 102 during the registration procedure to confirm that fob 102 transponder identifier and other information is properly associated with the fob user and the fob user's specific biometric samples. The ASR may additionally employ one or more verification methods to confirm that the biometric sample belongs to the user, such as, for example, the ASR may request from the user demographic information, further biometric samples and/or any other information. As used herein, “confirm”, “confirmation” or any similar term includes verifying or substantially verifying the accuracy, existence, non-existence, corroboration, and/or the like of the information, component, or any portion thereof. The ASR may additionally employ one or more additional processing methods in order to facilitate association of a biometric sample. As used herein, the term processing may include scanning, detecting, associating, digitizing, printing, comparing, storing, encrypting, decrypting, and/or verifying a biometric and/or a biometric sample, or any portion thereof.

Upon association, authentication and/or verification of the biometric sample and fob 102, the system may store the sample and fob 102 identifier (step 1409) in one or more databases on and/or in communication with system 100 via a network, server, computer, or any other means of communicating as described herein. The database(s) may be any type of database described herein. For example, a biometric sample stored on fob 102 may be stored in database 212 and/or on databases found in engine 130. The database(s) may be located at or operated by any of the entities discussed herein such as, for example, the ASR and/or by a third-party biometric database operator.

The information stored in the database may be sorted or stored according to one or more characteristics associated with the sample in order to facilitate faster access to the stored sample. For example, fingerprint samples may be stored in a separate database than voice prints. As another example, all fingerprints with certain whirl patterns may be stored in a separate sub-database and/or database from fingerprints with arch patterns.

The biometric samples may also be stored and/or associated with a personal identification number (PIN) and/or other identifier to facilitate access to the sample. The PIN may be fob user selected or randomly assigned to the biometric sample. The PIN may consist of any characters such as, for example, alphanumeric characters and/or foreign language characters.

The system may further protect the samples by providing additional security with the sample. The security may include, for example, encryption, decryption, security keys, digital certificates, firewalls and/or any other security methods known in the art and discussed herein. One or more security vendors may utilize the security methods to store and/or access the biometric samples. The present invention anticipates that storage of the biometric samples may be such that a sample is first encrypted and/or stored under a security procedure, such that the sample may only be accessed by a vendor with the proper level of access or security which corresponds to or provides access to the stored sample. The samples may be accessible by certain vendors such as, for example, fob 102 transaction account provider system, a healthcare system, an issuer system, a healthcare provider system, a fob issuer system, an employer, a financial institution, a non-financial institution, a loyalty-point provider, a company, the military, the government, a school, a travel entity, a transportation authority, and/or a security company.

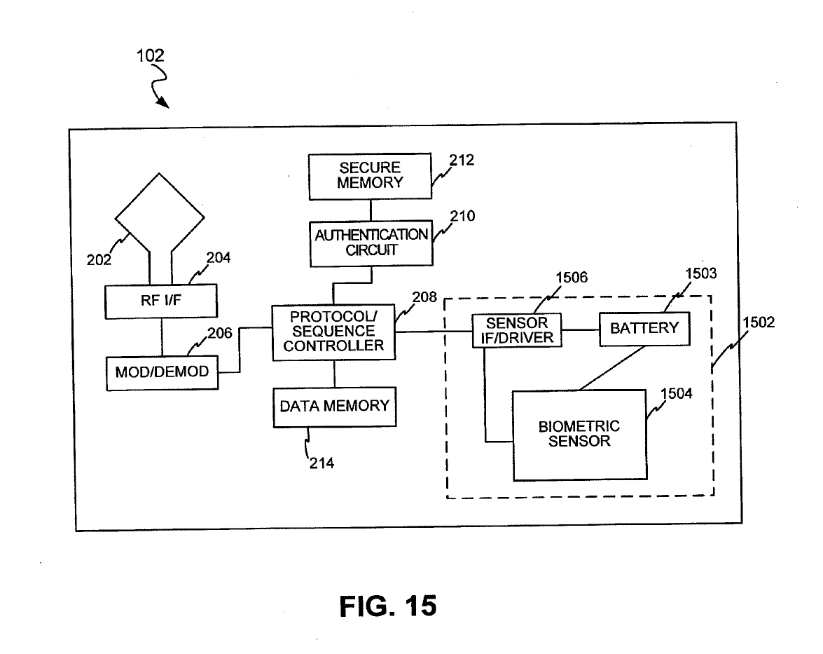

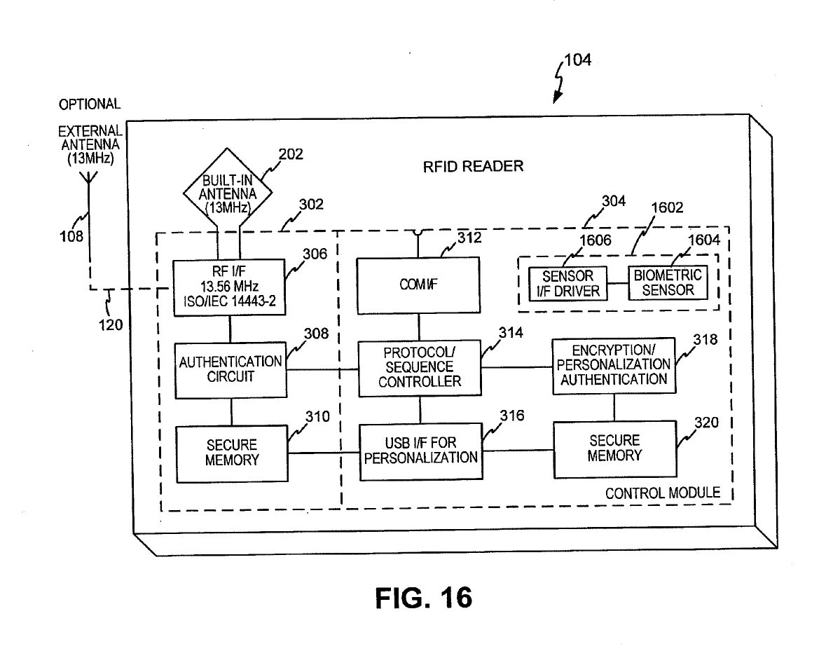

The fob of the invention may include a particular security system wherein the security system incorporates a particular biometric system. As shown in FIG. 15, fob 102 includes a biometric security system 1502 configured for facilitating biometric security using, for example, fingerprint samples. Alternatively, as shown in FIG. 16, RFID reader 104 includes a biometric security system 1602 configured for facilitating biometric security using biometric samples. As used herein, fingerprint samples may include samples of one or more fingerprints, thumbprints, palmprints, footprints, and/or any portion thereof. Biometric security system 1502, 1602 may include a biometric sensor 1504, 1604 which may be configured with a sensor and/or other hardware and/or software for acquiring and/or processing the biometric data from the person such as, for example, optical scanning, capacitance scanning, or otherwise sensing the portion of fob user. In one embodiment, biometric sensor 1504, 1604 of the security system 1502, 1602 may scan a finger of a fob user in order to acquire his fingerprint characteristics into fob 102. Biometric sensor 1504, 1604 may be in communication with a sensor interface/driver 1506, 1606 such that sensor interface 1506, 1606 receives the fingerprint information and transmits a signal to controller 208, 308 to facilitate activating the operation of fob 102. A power source (e.g., battery 1503) may be in communication with biometric sensor 1504, 1604 and sensor interface 1506, 1606 to provide the desired power for operation of the biometric security system components.

In one exemplary application of fob 102 incorporating biometric security system 1502, the user may place his finger on the biometric sensor to initiate the mutual authentication process between fob 102 and RFID reader 104, and/or to provide verification of the user's identity. Fob 102 may digitize the fingerprint and compare it against a digitized fingerprint stored in a database (e.g., security database 212) included on fob 102. The fingerprint information may additionally be compared with information from one or more third-party databases communicating with fob 102 through any communication software and/or hardware, including for example, RFID reader 104, a USB connection, a wireless connection, a computer, a network and/or any other means for communicating. This transfer of information may include use of encryption, decryption, security keys, digital certificates and/or other security devices to confirm the security of the sample. Fob 102 may additionally communicate with third-party databases to facilitate a comparison between fob 102 identifier and other fob identifiers stored with the biometric samples. As used herein, “compare,” “comparison” and similar terms may include determining similarities, differences, existence of elements, non-existence of elements and/or the like.

Protocol/sequence controller 208 may facilitate the local comparison to authenticate the biometric and authentication circuit 210 may validate the information. Any of the embodiments may alternatively or additionally include remote comparisons performed or controlled by one or more third-party security vendors. One or more comparison techniques and/or technologies may be used for comparisons. For example, for fingerprint comparisons, protocol/sequence controller 208 may utilize an existing database to compare fingerprint minutia such as, for example, ridge endings, bifurcation, lakes or enclosures, short ridges, dots, spurs and crossovers, pore size and location, Henry System categories such as loops, whorls, and arches, and/or any other method known in the art for fingerprint comparisons.

Fob 102 may additionally be configured with secondary security procedures to confirm that fake biometric samples are not being used. For example, to detect the use of fake fingers, fob 102 may be further configured to measure blood flow, to check for correctly aligned ridges at the edges of the fingers, and/or any other secondary procedure to reduce biometric security fraud. Other security procedures for ensuring the authenticity of biometric samples may include monitoring pupil dilation for retinal and/or iris scans, pressure sensors, blinking sensors, human motion sensors, body heat sensors and/or any other procedures known in the art for authenticating the authenticity of biometric samples.

After verifying the biometric information, fob 102 and RFID reader 104 may begin mutual authentication, and the information and/or financial transaction may proceed accordingly. However, the invention contemplates that the verification of biometric information may occur at any point in the transaction such as, for example, after the mutual authentication. At any point in the transaction, the system may additionally request fob user to enter a PIN and/or other identifier associated with the transaction account and/or biometric sample to provide further verification of fob user's identification. As part of the transaction, fob user payor may be requested to select from one of the insurance accounts, healthcare accounts, financial accounts, loyalty accounts, credit accounts, debit account, and/or other accounts associated with the biometric sample. The user may be presented with a list of account options on a display associated with RFID reader 104, fob 102, a third-party security device and/or any other financial or transaction device association with a transaction. In another embodiment, a payee may select one of the accounts. For example, a hospital payee may manually and/or automatically select a specific medical insurance account, if available, for a transaction.

RFID reader 104 may also be configured with secondary security procedures biometric to confirm that fake biometric samples are not being used. For example, RFID reader 104 may be further configured to measure blood flow, body heat and/or any other secondary procedure to reduce biometric security fraud. Other security procedures for ensuring the authenticity of biometric samples may include monitoring pupil dilation for retinal and/or iris scans, pressure sensors, blinking sensors, human motion sensors, and/or any other procedures known in the art for authenticating the authenticity of biometric samples. After verifying the biometric information, fob 102 and RFID reader 104 may begin mutual authentication, and the transaction may proceed accordingly.

While the biometric safeguard mechanisms describe fob 102 and/or RFID reader 104 configured with a biometric safeguard mechanism, any part of system 100 may be equipped with a biometric safeguard system. For example, the invention contemplates receiving a biometric sample only at the reader, only at the fob, at both the fob and the reader, or at any other combination of location or device. As such, any scanner or database discussed herein may be located within or associated with another device. For example, the fob may scan a user biometric, but the database used for comparison may be located within the reader or healthcare server. In other embodiments, the biometric security device may be located away from the point-of-interaction device and/or provide other functions. In one embodiment, the biometric security device may be located outside of an emergency room intake area to allow a user to not only start the authentication process before check-in, but also to allow expedited insurance authentication of a patient for medical procedures. In this regard, the biometric security device may communicate the information to the point-of-interaction device so the POI may verify that the person that checked into the hospital is the same person that is now receiving medical attention. In another embodiment, any portion of system 100 may be configured with a biometric security device. The biometric security device may be attached and/or free-standing. Biometric security devices may be configured for local and/or third-party operation. For example, the present invention contemplates the use of third-party fingerprint scanning and security devices such as those made by Interlink Electronics, Keytronic, Identix Biotouch, BIOmetricID, onClick, and/or other third-party vendors.

In yet another embodiment, the database used for comparison may contain terrorist and/or criminal information. As used herein, terrorists and/or criminals may include terrorists, felons, criminals, convicts, indicted persons, insurgents, revolutionaries and/or other offenders. The information may include biometric information, personal information as described herein, arrest records, aliases used, country of residence, affiliations with gangs and terrorist groups, and/or any other terrorist and/or criminal information.

As an example of a secondary security procedure in accordance with the present invention, the biometric sensor 1504, 1604 and/or RFID reader 104 may be configured to allow a finite number of scans. For example, biometric sensor 1504, 1604 may be configured to only accept data from a single scan. As a result, biometric sensor 1504, 1604 may turn off or deactivate fob 102 and/or RFID reader 104 if more than one scan is needed to obtain a biometric sample. Biometric sensor 1504, 1604 may also be configured to accept a preset limit of scans. For example, biometric sensor 1504, 1604 may receive three invalid biometric samples before it turns off and/or deactivates fob 102 and/or RFID reader 104.

The sensor or any other part of system 100 may also activate upon sensing a particular type or group of biometric samples. The activation may include sending a signal, blinking, audible sound, visual display and/or the like. For example, if the sensor detects information from a specific insurance holder, the system may display a special information on the POI terminal. In another embodiment, the system may send a signal to a primary account holder or any other person or device to notify them that the fob is being used or that a condition or rule is being violated (e.g., certain user information is being accessed).

Any of the biometric security systems described herein may additionally be configured with a fraud protection log. That is, a biometric security system, such as biometric security system 1502, 1602 may be configured to log all biometric samples submitted on fob 102 and/or RFID reader 104 and store the log information on databases on and/or communicating with system 1502, 1602. If a new and/or different biometric sample is submitted that differs from the log data, biometric security system 1502, 1602 may employ a security procedure such as deactivation, warning authorities, requesting a secondary scan, and/or any other security procedure.

Biometric security system 1502, 1602 and/or the biometric security system configured with system 100 may also be configured to obtain a plurality of biometric samples for verification and/or other security purposes. For example, after biometric security system 1502, receives a first biometric sample (e.g., scans one finger), it may be configured to receive a second biometric sample (e.g., scans a second finger). The first and second biometric samples may be compared with stored biometric samples by any of the methods disclosed herein. The second biometric sample may be the only sample compared with stored biometric samples if the first sample is unreadable or inadequate.

While the biometric safeguard mechanisms described herein use fingerprint scanning and retinal scanning for biometric sample verification for exemplification, any biometric sample may be submitted for verification, authorization and/or any other safeguard purpose. For example the present invention contemplates the use of voice recognition, facial and/or ear recognition, signature recognition, vascular patterns, DNA sampling, hand geometry, auditory emissions recognition, olfactory recognition, keystroke/typing recognition, iris scans, and/or any other biometric known in the art.

In yet another exemplary application of the present invention, fob 102 may be configured for use with global positioning technologies. For example, fob 102 may include any combination of positioning technology such as global position system (GPS), wireless assisted GPS, wireless assisted protocol (WAP) based location, geography markoff language (GML) based location, differential GPS, enhanced observed time difference (E-OTD), enhanced cell identification, and uplink time difference of arrival (U-TDOA) technologies. Fob 102 may be configured to communicate its positional information to one or more servers on network 136 and/or engine 130 to provide information based on the location of fob 102. For example, a user may be use a GPS-enabled fob 102 to determine the nearest location of a healthcare provider.

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Further, the present invention may be practiced using one or more servers, as necessary. Thus, the preceding detailed description is presented for purposes of illustration only and not of limitation, and the scope of the invention is defined by the preceding description, and with respect to the attached claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

1. (canceled)

2. A method comprising:
determining, by a computerized component of a healthcare system, that a user is associated with at least one insurance data set;
determining, by the computerized component, that the at least one insurance data set is not present on a fob associated with the user;
providing, by the computerized component, programming information to the fob, wherein the programing information is configured to cause the fob to store each of the at least one insurance data set in a respective data storage area on the fob; and
obtaining, by the computerized component, a preference setting selection for the at least one insurance data set, wherein the preference setting selection is accessed in processing a transaction request initiated, at least in part, using the fob.

3. The method of claim 1, further comprising determining, by the computerized component, that a primary insurance data set of the at least one insurance data set being unable to complete the transaction request.

4. The method of claim 2, further comprising completing, by the computerized component, the transaction request with a secondary insurance data set of the at least one insurance data set.

5. The method of claim 1, wherein the preference setting selection includes setting a primary insurance data set of the at least one insurance data set to be used for a first type of healthcare transaction.

6. The method of claim 4, further comprising obtaining, by the computerized component, a second preference setting selection for the at least one insurance data set, wherein the second preference setting selection is accessed in processing the transaction request.

7. The method of claim 5, wherein the second preference setting selection includes setting a secondary insurance data set of the at least one insurance data set to be used for a second type of healthcare transaction different from the first type of healthcare transaction.

8. The method of claim 1, wherein in response to the transaction request being initiated, the at least one insurance data set is read from the fob.

9. The method of claim 1, further comprising determining which of the at least one insurance data set is to be applied based on the preference settings selection.

10. The method of claim 1, further comprising obtaining, by the computerized component, secondary identification to verify the user prior to storing the at least one insurance data set.

11. The method of claim 1, further comprising updating the at least one insurance data set in response to a presentation of the fob at a point-of-interaction.

12. A non-transitory computer-readable medium storing executable instructions that, when executed, cause a computerized component of a healthcare system to perform operations comprising:
determining, by the computerized component of a healthcare system, that a user is associated with at least one insurance data set;
determining, by the computerized component, that the at least one insurance data set is not present on a fob associated with the user;
providing, by the computerized component, programming information to the fob, wherein the programing information is configured to cause the fob to store each of the at least one insurance data set in a respective data storage area on the fob; and
obtaining, by the computerized component, a preference setting selection for the at least one insurance data set, wherein the preference setting selection is accessed in processing a transaction request initiated, at least in part, using the fob.

13. The non-transitory computer-readable medium of claim 11, further comprising:
determining, by the computerized component, that a primary insurance data set of the at least one insurance data set being unable to complete the transaction request; and
completing, by the computerized component, the transaction request with a secondary insurance data set of the at least one insurance data set.

14. The non-transitory computer-readable medium of claim 11, wherein the preference setting selection includes setting a primary insurance data set of the at least one insurance data set to be used for a first type of healthcare transaction.

15. The non-transitory computer-readable medium of claim 13, further comprising obtaining, by the computerized component, a second preference setting selection for the at least one insurance data set, wherein the second preference setting selection is accessed in processing the transaction request,
wherein the second preference setting selection includes setting a secondary insurance data set of the at least one insurance data set to be used for a second type of healthcare transaction different from the first type of healthcare transaction.

16. The non-transitory computer-readable medium of claim 11, wherein in response to the transaction request being initiated, the at least one insurance data set is read from the fob.

17. The non-transitory computer-readable medium of claim 11, further comprising determining which of the at least one insurance data set is to be applied based on the preference settings selection.

18. The non-transitory computer-readable medium of claim 11, further comprising obtaining, by the computerized component, secondary identification to verify the user prior to storing the at least one insurance data set.

19. The non-transitory computer-readable medium of claim 11, further comprising updating the at least one insurance data set in response to a presentation of the fob at a point-of-interaction.
